(19) United States
(12) Patent Application Publication
(10) Pub. No.: US 2017/0243245 A1
(43) Pub. Date: Aug. 24, 2017

(54) METHODS, APPARATUSES, AND SYSTEMS FOR FACILITATING MANAGEMENT AND/OR AUTOMATION OF DIRECT MAIL CAMPAIGNS AND OTHER BULK/HIGH VOLUME MAILINGS

(71) Applicant: KleerMail Corporation, Boston, MA (US)

(72) Inventor: Christopher Nolan, Boston, MA (US)

(21) Appl. No.: 15/281,427

(22) Filed: Sep. 30, 2016

Related U.S. Application Data
(63) Continuation of application No. PCT/US2015/023692, filed on Mar. 31, 2015.
(60) Provisional application No. 61/973,166, filed on Mar. 31, 2014.

(51) Int. Cl. G06Q 30/02; G06Q 10/06

(52) U.S. Cl. CPC G06Q 30/0251; G06Q 10/0631; G06F 3/04847

(57) ABSTRACT

Methods, apparatuses, and systems for facilitating and/or automating project specification, vendor/supplier selection, packaging/processing, and/or mailing for direct mail campaigns to deliver printed promotional material to a target audience. A project manager of a direct mail campaign electronically provides various project information (e.g., project type, design specifications and quantities of materials, mailing list(s), deadlines). Multiple authorized suppliers of services germane to direct mail campaigns (e.g., print shops, lettershops) electronically access the project information and provide respective bids to perform services required by the project, from which the project manager may select one or more suppliers to perform corresponding services. The curated computer-facilitated environment provides significant outsourcing capability, with price transparency, to entities desiring to run direct mail campaigns, and further provides increased predictability of demand and control over pricing decisions to suppliers of direct mail services. Disclosed concepts similarly are applicable to other types of bulk or high volume mailings.

### CROSS-REFERENCE TO RELATED APPLICATIONS

This application is a bypass continuation application of International Application No. PCT/US2015/023692, filed on Mar. 31, 2015 and entitled “METHODS, APPARATUS, AND SYSTEMS FOR FACILITATING MANAGEMENT AND/OR AUTOMATION OF DIRECT MAIL CAMPAIGNS AND OTHER BULK/HIGH VOLUME MAILINGS,” which in turn claims a priority benefit to U.S. Provisional Patent Application Ser. No. 61/973,166, filed Mar. 31, 2014, and titled “METHODS, APPARATUSES, AND SYSTEMS FOR FACILITATING MANAGEMENT AND/OR AUTOMATION OF DIRECT MAIL CAMPAIGNS AND OTHER BULK/HIGH VOLUME MAILINGS.” Each of the aforementioned applications is herein expressly incorporated by reference in its entirety.

### BACKGROUND

A company or agency seeking to communicate via conventional mail with a significant number of existing and/or prospective customers and clients often must navigate a complex supply chain in order to produce and deliver printed materials to the customers/clients. Examples of activities in the supply chain of conventional bulk or “high-volume” mail campaigns include: procuring customer/client mailing lists; coordinating the production of printed material with printers; coordinating the assembly and addressing of mail pieces with lettershops; ensuring quality control throughout the production process; sorting mail to satisfy U.S. Postal Service (USPS) requirements and qualify for bulk postage discounts; coordinating shipping and logistics; and tracking the communication through the mail stream to ensure delivery (and in some instances trigger marketing efforts).

Variances in execution and delivery of different material and/or service providers for bulk mail campaigns introduce significant financial risk for the performance of a given bulk mail campaign due to costs and timing of offers to perform various bulk mail services. As a result, frequent or high-volume mailers typically are required to employ large production staffs, or engage third parties (marketing agencies) to ensure timely and quality execution of bulk mail campaigns. Further, mailers seeking to procure various bulk mail services are faced with a “principal agent dilemma,” whereby supply chain partners are in some instances incentivized to increase the volume and complexity of mailings to the detriment of a given mail campaign's return-on-investment (ROI). Furthermore, price discovery for materials and/or bulk mail services is typically challenging for mailers, due to an overall lack of data and market transparency.

Bulk mail service providers seeking to sell supply chain services, such as lettershop or commercial printing, must make substantial investments in fixed assets and face a highly saturated, fragmented, and inefficient marketplace with a number of undifferentiated small and middle-market participants. These marketplace dynamics often result in increased search costs and time and minimal pricing power. Supply chain services are subject to demand-based pricing, resulting in frequent discounting during periods of low demand. Suppliers generally market their services through national outbound sales teams and often pay commissions up to 10% of gross sales. Revenues for such bulk mail suppliers are highly dependent on the effort of a supplier's sales staff, resulting in unpredictable demand for direct mail production services.

### SUMMARY

In view of the foregoing, various inventive embodiments disclosed herein are directed to methods, apparatuses and systems for facilitating and/or automating bulk or “high-volume” mail campaigns to deliver printed material to a target audience. Examples of printed material delivered via the bulk or high-volume mail campaigns to which the inventive concepts described herein are applicable include, but are not limited to, financial statements, invoices, insurance-related materials, healthcare/medical claim-related materials, employment/labor-related materials, politically-related materials (e.g., election campaign materials), and promotional materials delivered via a “direct mail” campaign.

More specifically, some inventive embodiments disclosed herein are directed to methods, apparatuses, and systems for facilitating and/or automating project specification, vendor/supplier selection, packaging/processing, and/or mailing for direct mail campaigns to deliver printed promotional material to a target audience. Via computer-facilitated techniques, a project manager (or other authorized user) of a direct mail campaign may electronically provide various project information (e.g., project type, design specifications and quantities of materials, mailing list(s), deadlines). Multiple authorized suppliers of services germane to direct mail campaigns (e.g., print shops, lettershops) may then electronically access the project information and in turn may provide respective bids to perform at least some services required by the project. The project manager (or other authorized user) may then select one or more suppliers, based on the respective bids, to perform corresponding services in support of executing the campaign. The curated computer-facilitated environment provides significant outsourcing capability, with price transparency, to entities desiring to run direct mail campaigns, and further provides increased predictability of demand and control over pricing decisions to suppliers of direct mail services. The various concepts disclosed in connection with direct mail campaigns similarly may be applied to other types of bulk or high volume mailings (e.g., not necessarily involving printed promotional materials, but other types of printed materials as noted above).

The term “bulk mail” generally refers to larger quantities of mail prepared for mailing at reduced postage rates, without regard to the type of printed material contained in the mailings or the purpose of the mailings. For example, the USPS uses the term “bulk mail” and “presorted mail” interchangeably in connection with commercial First-Class Mail as well as advertising mail (also called “Standard Mail” by the USPS). Bulk mail postage rates invariably are lower than postage rates for “single-piece” mailings (e.g., in which a single letter/package is stamped or otherwise rated/metered). Lower bulk mail postage rates typically are dictated by a certain minimum number of pieces that are involved in the mailings (e.g., typically on the order of at least 200-300 or higher numbers of mailings via the USPS).

“Direct mail” generally refers to a marketing channel that utilizes a mail service (e.g., the U.S. Postal Service or “USPS”) to deliver printed promotional material to a target audience. Examples of printed promotional material that may be delivered to a target audience pursuant to a direct mail campaign include, but are not limited to, postcards, “self-mailers,” booklets, brochures, catalogues, newsletters, and sales letters. Thus, it should be appreciated that the printed promotional material in a direct mail campaign may include one or more physical components of printed material that may be assembled or otherwise packaged together in a variety of formats (e.g., a single-page newsletter that is folded in a particular manner, sealed and addressed; an envelope containing a cover letter and a brochure; a postcard packaged with a catalogue to which a mailing label is attached; etc.) for delivery to respective mail recipients of the target audience.

To this end, one or more program managers (or other administrators) for a direct mail campaign typically procure, manage, and rely on various direct mail service providers to create/design the printed promotional material, physically generate the printed promotional material (e.g., printing), and package/prepare the printed promotional material for delivery via a mail service such as the USPS. More specifically, one of the salient service providers in a direct mail supply chain (or, more generally, a bulk mail supply chain) includes “lettershops.” For purposes of the present disclosure, and as readily recognized in the relevant arts, a lettershop may be any clerical operation and/or service organization that is capable of preparing large volume mailings. Examples of lettershop services include, but are not limited to: retrieving and/or procuring stock (e.g., from a warehouse or materials supply source) for one or more physical components of printed material; collating mailing package components; addressing, personalizing, trimming, and/or folding one or more physical components of printed material; using mechanical inserters to insert one or more package components into an outer envelope; preparing printed material for mailing to recipients of the target audience according to U.S. Postal Service and/or other national postal service regulations for entry into a mail system; and physical delivery to a USPS (or other postal service) point of entry. Additionally, while printers/print shops may provide printing-related services as distinct services apart from those provided by lettershops, in some examples a lettershop itself may provide some or all of the printing services required for a given bulk/direct mail campaign.

In various inventive embodiments described in detail further below, a computer-facilitated bulk mail/direct mail management and automation platform may be implemented in a client-server architecture that allows program managers and other administrators overseeing a bulk mail/direct mail campaign (e.g., also referred to herein more generally as “users”) to communicate with multiple suppliers of bulk mail/direct mail services (e.g., print shops, lettershops—also referred to herein more generally as “suppliers”), via a bulk mailing management server so as to procure necessary services and thereby effectively and efficiently execute the campaign. In this manner, these “users” and “suppliers” are respective clients communicating and exchanging relevant information regarding the campaign via one or more servers constituting the bulk mailing management server. In some embodiments, communication and information exchange between and amongst respective clients (e.g., users and suppliers) is implemented by the server via various graphical user interfaces (GUIs) that are provided on respective client devices to facilitate entry of relevant information, including various specifications for the printed material being delivered pursuant to the bulk/direct mail campaign, and respective bids from different suppliers for performing various services in support of executing the campaign. In some implementations, a bulk mailing management server serving as a bulk/direct mail automation platform may be accessed by respective clients via one or more computing devices, examples of which include but are not limited to a personal computer and various mobile devices (e.g., a mobile phone, a tablet, a PDA, or a similar device).

Illustrative functionality that may be implemented and/or otherwise facilitated by a bulk mailing management server according to various embodiments may include one or more of: procuring of mailing lists for the target audience; coordinating the procurement and/or production of printed materials with suppliers; coordinating the assembly and addressing of mail pieces with suppliers; ensuring quality control throughout the production process; sorting mail to satisfy USPS and/or like national and/or federal requirements in order to qualify for postage and/or like discounts; coordinating shipping and logistics; and tracking communication through the supply chain to ensure effective delivery of printed material (and, in some instances, to trigger additional marketing efforts).

More specifically, in some implementations a mail campaign program manager or other authorized administrator (“user”) may provide to a bulk mailing management server (via a GUI displayed on a client computing device) project specifications such as the type of printed material (e.g. a postcard, a self-mailer, a catalog and/or booklet, a generic letter package, or a personalized letter package), a name for the project/campaign, a quantity of mailings to be delivered pursuant to the campaign, details about one or more components of printed material (e.g., type of paper, size of envelopes), images and/or templates detailing the layout and/or appearance of the project components, and deadlines for bidding on and completing the campaign. The user may provide this information while logged into a user profile account, which may be populated with information such as the user's contact information, a description of the user's business and/or goals, and a history of past orders. The client interface may suggest and/or provide templates (e.g., GUIs) for the user to utilize for various components and/or project types. Users also may be able to create new templates, edit existing templates, and/or otherwise specify alternative templates for use for a particular project and/or a particular type of project. In some implementations, user-defined production of a pre-defined template may be initiated via user-specified events and/or dates.

The bulk mailing management server may process the user's data and provide it via a web interface to multiple authorized suppliers of bulk/direct mail services. Respective suppliers may have corresponding profiles to access the bulk mailing management server via client devices, wherein an example supplier profile may contain information including, but not limited to, the supplier's contact information, location, a business profile, and tax information. In some implementations, the supplier may be able to view a list of all pending requests from users for bulk/direct mail services which have not been fulfilled. In other implementations, each supplier may only be able to view specifications for a given campaign that it has been invited to bid on by a user. In such implementations, users may be given the opportunity to choose which suppliers may access and/or bid on their projects (e.g. by choosing from a platform-provided list of suppliers, and/or via uploading a user-generated list of suppliers). Suppliers provided and/or chosen by the user may be added to the user's supplier list.

Once having access to various project specifications, respective suppliers may place bids to provide services for one or more aspects of the campaign. For example, if the printed material for a given campaign comprises an envelope, a letter, and an advertisement insert, a supplier may bid on the envelopes, the letters, and/or the insert, and may provide cost estimates for each physical component of the printed material, and/or for the printed material package as a whole, based on the quantities provided by the user. In some implementations the supplier may not be able to view bids submitted by other suppliers. The supplier's bid may be stored as part of a record in a database and may be linked to the user. Each supplier may be required to bid on a campaign within a user-specified time limit (e.g., in order to allow for sufficient time to process the requests for supplier services and/or to otherwise ensure the campaign will be completed on time). Suppliers may also be able to view the deadline of a particular project in order to determine whether they are capable of completing the project on time given the specified parameters.

The user may be able to review bids submitted by suppliers (e.g., after a user-specified bidding period has ended). In some implementations, the lowest bid for each component of printed material may be highlighted and/or otherwise noted to the user such that the user may quickly view the lowest cited prices for each component. For example, two suppliers (e.g., Supplier A and Supplier B) may bid on a campaign including a quantity of 5,000 mailings of printed material comprising an envelope, a letter, and an advertisement insert. Supplier A may quote costs of $500 for the envelopes, $600 for the letters, and $400 for the advertisement insert, for a total cost of $1,500; Supplier B may quote costs of $300 for the envelopes, $400 for the letters, and $700 for the advertisement inserts, for a total cost of $1,400. Via the functionality of the bulk mailing management server, the user may be able to see that Supplier A quoted a lower cost for the advertisement inserts, but that Supplier B quoted lower costs for the envelopes and letters. In some implementations, the user may be able to choose Supplier B to fulfill the entire project for $1,400, and/or may be able to choose Supplier B to process the envelopes and the letters, and to choose Supplier A to process the advertisement inserts for $1,100, and/or any permutation thereof. The user may then be able to confirm which bids are accepted and/or rejected and submit the order to the appropriate supplier(s) for processing.

As may be readily appreciated from the foregoing, a bulk mailing management server according to various embodiments provides for increased price competition and transparency for various bulk/direct mail services. Suppliers may also benefit from increased demand visibility, increased supply chain efficiency and cost-effective procurement of direct mail (allowing for decreased overall costs and enhanced program return-over-investment (ROI)), as well as from analytic opportunities that may be made available via large volumes of automated bulk/direct mail transactions. Users may be able to buy, manage, track, and analyze bulk/direct mail campaigns, enabling mailers to experience the same ease of use, efficiency and reporting that is typically associated with online and digital marketing channels. In other aspects, methods, apparatuses and systems according to some embodiments may be configured for subscription-based access in order to provide different functions to different users and/or suppliers based on their needs (e.g., based on how many projects a user may need to create and/or process, based on the level of internal direct mail resources possessed by the user, and based on the average volume of direct mail projects created and/or processed by the user). In some implementations, subscription and/or licensing fees may vary based on the type of service provided, the volume of a project, and production costs for each and/or the average project.

In some implementations, an example apparatus for facilitating management, by at least one project manager, of a direct mail campaign to generate and deliver printed promotional material to a target audience including multiple direct mail recipients, can include at least one communication interface, a memory to store processor-executable instructions, and at least one processor communicatively coupled to the at least one communication interface and the memory, wherein upon execution by the at least one processor of at least some of the processor-executable instructions stored in the memory, the at least one processor controls the at least one communication interface to perform a number of tasks. Said tasks can include electronically transmitting first information for electronically displaying to the at least one project manager, on at least one project manager computer communicatively coupled to the at least one communication interface, at least one graphical user interface (GUI) relating to a plurality of specifications for the direct mail campaign, each specification of the plurality of specifications having at least one user-defined variable parameter, the at least one (GUI) facilitating at least one designation by the at least one project manager of the at least one user-defined variable parameter for at least one specification of the plurality of specifications. The processor can also electronically receive the at least one user-defined variable parameter for the at least one specification, from the at least one project manager computer, based at least in part on the at least one designation by the at least one project manager via the at least one GUI.

The processor can also electronically transmit the at least one user-defined variable parameter for the at least one specification for the direct mail campaign to multiple suppliers of direct mail lettershop services, via a respective plurality of supplier computers communicatively coupled to the at least one communication interface, wherein the multiple suppliers are identified in a supplier list or supplier database that is stored in the at least one memory and/or electronically received via the at least one communication interface. The processor can also electronically receive respective bids from the multiple suppliers, via the respective plurality of supplier computers, to perform at least some of the direct mail lettershop services, based at least in part on the at least one user-defined variable parameter for the at least one specification. The processor can also electronically transmit second instructions for displaying to the at least one project manager, via the at least one GUI of the at least one project manager computer, the respective bids from the multiple suppliers, the at least one (GUI) facilitating selection by the at least one project manager of at least one of the multiple suppliers to perform the at least some of the direct mail lettershop services. The processor can also electronically receive, from the at least one project manager computer, a supplier indication corresponding to the at least one of the multiple suppliers to perform the at least some of the direct mail lettershop services, based at least in part on the selection by the at least one project manager via the at least one GUI displayed on the at least one project manager computer.

The example apparatus can allow the at least one processor to further control the at least one communication interface to electronically transmit to the at least one of the multiple suppliers, via a corresponding one of the plurality of supplier computers and based at least in part on the supplier indication, a confirmation instruction to perform the at least some of the direct mail lettershop services pursuant to the at least one user-defined variable parameter for the at least one specification for the printed promotional materials. In some implementations, the plurality of specifications for the direct mail campaign include: a type specification for a type of the printed promotional material, a quantity specification for a quantity of the printed promotional material, and/or at least one component specification relating to at least one physical component of the printed promotional material. In some implementations, the plurality of specifications for the direct mail campaign can further include: a data processing specification relating to processing of at least one mailing list for the multiple direct mail recipients, and/or a mailing specification relating to delivery of the printed promotional material to the multiple direct mail recipients.

In some implementations, the at least one processor can further control the at least one communication interface to electronically receive the at least one mailing list for the multiple direct mail recipients of the target audience, and the respective bids from the multiple suppliers can be based at least in part on at least one of the data processing specification and the mailing specification. The data processing specification can include at least one of a merge specification, a de-duplication specification, and a purge specification. In some implementations, the mailing specification can include at least one of a matched mailing specification, a personalization specification, a proofing specification, a postal sortation/presorting specification, and a postage rate specification. In some implementations, the at least one specification can include the type specification for the type of the printed promotional material, the at least one GUI can provide a list of options corresponding to multiple types of the printed promotional material to facilitate the at least one designation by the at least one project manager of one type of the multiple types as the at least one user-defined variable parameter for the type specification, and the multiple types of printed promotional material can include an envelope, a self-mailer, a postcard, a booklet, a brochure, a catalogue, a newsletter, and/or a promotional letter.

In some implementations, the at least one specification can include the quantity specification for the quantity of the printed promotional material, and the at least one (GUI) facilitates the at least one designation by the at least one project manager of the at least one user-defined variable parameter for the quantity specification as a number. The at least one specification can include the at least one component specification relating to the at least one physical component of the printed promotional material. The at least one component specification relating to the at least one physical component of the printed promotional material can include at least one of a size specification relating to a size of the at least one physical component, a material stock specification relating to at least one of a brand, a color, a weight, and a finish for the at least one physical component, an ink process specification relating to a ink process for the at least one physical component, a proof and/or press-check specification for the at least one physical component, and/or a personalization specification for the at least one physical component. In some implementations, the at least one component specification relating to the at least one physical component of the printed promotional material can be based at least in part on the type specification for the type of the printed promotional material. The at least one component specification includes a plurality of component specifications, and at least one of a number and respective attributes for the plurality of component specifications is based at least in part on the type specification for the type of the printed promotional material.

In some implementations, the direct mail lettershop services can include at least one of retrieving and/or procuring stock for at least one physical component of the printed promotional material, collating, addressing, personalizing, trimming, and/or folding the at least one physical component of the printed promotional material, inserting the at least one physical component into an outer envelope, preparing the printed promotional material for mailing to the multiple recipients of the target audience according to postal service regulations, and/or physically delivering the printed promotional material to a U.S. Postal Service point of entry. In some implementations, the direct mail lettershop services further comprise printing the at least one package component of the printed promotional material.

In some implementations, the processor can electronically transmitting timeline information for electronically displaying on the at least one project manager computer, as part of the at least one GUI, a timeline providing a plurality of graphic indicators respectively corresponding to a sequence of stages of the direct mail campaign.

In some implementations, an exemplary computer-implemented process for facilitating management, by at least one project manager, of a direct mail project to generate and deliver printed promotional material to a target audience including multiple direct mail recipients, can include electronically transmitting, via at least one communication interface, first information for electronically displaying to the at least one project manager, on at least one project manager computer communicatively coupled to the at least one communication interface, at least one graphical user interface (GUI) relating to a plurality of specifications for the direct mail campaign, each specification of the plurality of specifications having at least one user-defined variable parameter, the at least one (GUI) facilitating at least one designation by the at least one project manager of the at least one user-defined variable parameter for at least one specification of the plurality of specifications.

The process can also include electronically receiving, via the at least one communication interface and from the at least one project manager computer, the at least one user-defined variable parameter for the at least one specification, based at least in part on the at least one designation by the at least one project manager via the at least one GUI. The process can also include electronically transmitting, via the at least one communication interface, the at least one user-defined variable parameter for the at least one specification for the direct mail campaign to multiple suppliers of direct mail lettershop services, via a respective plurality of supplier computers communicatively coupled to the at least one communication interface, wherein the multiple suppliers are identified in a supplier list or supplier database that is stored in the at least one memory and/or electronically received via the at least one communication interface. The process can also include electronically receiving, via the at least one communication interface, respective bids from the multiple suppliers, via the respective plurality of supplier computers, to perform at least some of the direct mail lettershop services, based at least in part on the at least one user-defined variable parameter for the at least one specification. The process can also include electronically transmitting, via the at least one communication interface, second instructions for displaying to the at least one project manager, via the at least one GUI of the at least one project manager computer, the respective bids from the multiple suppliers, the at least one (GUI) facilitating selection by the at least one project manager of at least one of the multiple suppliers to perform the at least some of the direct mail lettershop services. The process can also include electronically receiving, via the at least one communication interface and from the at least one project manager computer, a supplier indication corresponding to the at least one of the multiple suppliers to perform the at least some of the direct mail lettershop services, based at least in part on the selection by the at least one project manager via the at least one GUI displayed on the at least one project manager computer.

In some implementations, the process can also include electronically transmitting to the at least one of the multiple suppliers, via the at least one communication interface and a corresponding one of the plurality of supplier computers and based at least in part on the supplier indication, a confirmation instruction to perform the at least some of the direct mail lettershop services pursuant to the at least one user-defined variable parameter for the at least one specification for the printed promotional materials. In some implementations, the plurality of specifications for the direct mail campaign can include: a type specification for a type of the printed promotional material, a quantity specification for a quantity of the printed promotional material, at least one component specification relating to at least one physical component of the printed promotional material, a data processing specification relating to processing of at least one mailing list for the multiple direct mail recipients, and/or a mailing specification relating to delivery of the printed promotional material to the multiple direct mail recipients.

The process can also include electronically receiving, via the at least one communication interface, the at least one mailing list for the multiple direct mail recipients of the target audience, such that the respective bids from the multiple suppliers are based at least in part on at least one of the data processing specification and the mailing specification. In some implementations, the at least one GUI can provide a list of options corresponding to multiple types of the printed promotional material to facilitate the at least one designation by the at least one project manager of one type of the multiple types as the at least one user-defined variable parameter for the type specification, and the multiple types of printed promotional material include an envelope, a self-mailer, a postcard, a booklet, a brochure, a catalogue, a newsletter, and/or a promotional letter. In some implementations, the at least one component specification relating to the at least one physical component of the printed promotional material includes a plurality of component specifications, and at least one of a number and respective attributes for the plurality of component specifications is based at least in part on the type specification for the type of the printed promotional material. In some implementations, the at least one component specification relating to the at least one physical component of the printed promotional material can include at least one of: a size specification relating to a size of the at least one physical component, a material stock specification relating to at least one of a brand, a color, a weight, and a finish for the at least one physical component, an ink process specification relating to a ink process for the at least one physical component, a proof and/or press-check specification for the at least one physical component, and/or a personalization specification for the at least one physical component.

In some implementations, the process can also include electronically transmitting timeline information for electronically displaying on the at least one project manager computer, as part of the at least one GUI, a timeline providing a plurality of graphic indicators respectively corresponding to a sequence of stages of the direct mail campaign.

In some implementations, an example apparatus for facilitating management, by at least one project manager, of a direct mail campaign to generate and deliver printed promotional material to a target audience including multiple direct mail recipients, can include at least one display device, at least one user interface device, at least one communications interface, a memory to store processor-executable instructions, and/or at least one processor communicatively coupled to the at least one display device, the at least one user interface device, the at least one communications interface, and the memory, wherein upon execution by the at least one processor of at least some of the processor-executable instructions stored in the memory. In some implementations the at least one processor can control the at least one display device to display to the at least one project manager at least one graphical user interface (GUI) relating to at least one specification for the printed promotional material, the at least one specification having at least one user-defined variable parameter. The at least one processor can control at least one of the at least one display device and the at least one user input device to facilitate at least one designation, by the at least one project manager, of the at least one user-defined variable parameter for the at least one specification, based at least in part on the at least one GUI.

The at least one processor can control the at least one communication interface to electronically transmit the at least one user-defined variable parameter for the at least one specification to multiple suppliers of direct mail lettershop services, wherein the multiple suppliers are identified in a supplier list or supplier database that is stored in the at least one memory and/or electronically received via the at least one communication interface. The at least one processor can control the at least one communication interface to electronically receive respective bids from the multiple suppliers to perform at least some of the direct mail lettershop services, based at least in part on the at least one user-definable variable parameter for the at least one specification. The at least one processor can control the at least one display device to display to the at least one project manager, via the at least one GUI, the respective bids from the multiple suppliers. The at least one processor can also control at least one of the at least one display device and the at least one user input device to facilitate selection by the at least one project manager of at least one of the multiple suppliers to perform the at least some of the direct mail lettershop services, based at least in part on the at least one GUI.

In some implementations, an example apparatus for facilitating submission of a bid from a supplier of direct mail lettershop services to perform at least some direct mail lettershop services for a direct mail campaign to generate and deliver printed promotional material to a target audience including multiple direct mail recipients, can include: at least one user interface device, at least one communications interface, a memory to store processor-executable instructions, and at least one processor communicatively coupled to the at least one user interface device, the at least one communications interface, and the memory, wherein upon execution by the at least one processor of at least some of the processor-executable instructions stored in the memory. The at least one processor can control the at least one communications interface to electronically receive at least one user-defined variable parameter for at least one specification for the direct mail campaign. The at least one processor can also control the at least one communications interface to electronically transmit the bid to perform the at least some of the direct mail lettershop services based on the at least one specification for the direct mail campaign.

In some implementations, the at least one specification for the direct mail campaign can include: a type specification for a type of the printed promotional material, a quantity specification for a quantity of the printed promotional material, and/or at least one component specification relating to at least one physical component of the printed promotional material. The at least one specification for the direct mail campaign can also include: a data processing specification relating to processing of at least one mailing list for the multiple direct mail recipients, and/or a mailing specification relating to delivery of the printed promotional material to the multiple direct mail recipients. In some implementations, the direct mail lettershop services include at least one of: retrieving and/or procuring stock for at least one physical component of the printed promotional material, collating, addressing, personalizing, trimming, and/or folding the at least one physical component of the printed promotional material, inserting the at least one physical component into an outer envelope, preparing the printed promotional material for mailing to the multiple recipients of the target audience according to postal service regulations, and/or physical delivery of the printed promotional material to a U.S. Postal Service point of entry. In some implementations, the direct mail lettershop services can also include printing the at least one package component of the printed promotional material.

In some implementations, an exemplary computer-implemented process for facilitating direct mail automation can include receiving, via a processor, a request from a project manager to initiate a direct mail project, the request including an indication of a type of the direct mail project, and providing to the project manager, via at least one display device communicatively coupled to the processor, at least one project template based on the indication of the type of the direct mail project. The process can also include receiving from the project manager, via the processor, a completed direct mail project request based on the at least one project template, and providing, via at least one communication interface communicatively coupled to the processor, the completed direct mail project request to multiple suppliers of direct mail services via an invitation to bid on the direct mail project. The process can also include receiving from at least one supplier of the multiple suppliers, via the at least one communication interface, at least one bid for at least one component of the direct mail project, and providing, via the at least one display device, the at least one bid to the project manager. The process can also include receiving from the project manager, via the processor, an acceptance corresponding to an accepted one of the at least one bid, and providing, via the at least one communication interface, execution instructions to the at least one supplier who provided the accepted one of the at least one bid to execute the component of the direct mail project.

In some implementations, the process can also include receiving from the project manager a project deadline date, and requiring the at least one supplier to submit at the least one bid for the at least one component of the direct mail project before the project deadline date. In some implementations, the at least one bid is required to be submitted at a project manager-specified bidding deadline date, the specified bidding deadline date occurring before the project deadline date.

In some implementations, the process can also include receiving edits to at least a portion of the project template, and storing the edited project template in a database. The process can also include receiving a project manager-generated project template, and storing the project manager-generated project template in a database. The process can also include providing to the user a graphical interface indicating which of the at least one bid for at least one component of the direct mail project is least expensive. The process can also include providing to the user a graphical interface allowing the user to accept bids from at least two suppliers who have submitted bids for at least two components of the direct mail project.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The drawings are for illustrative purposes and are not intended to limit the scope of the inventive subject matter described herein. The drawings are not necessarily to scale; in some instances, various aspects of the disclosure herein may be shown exaggerated or enlarged in the drawings to facilitate an understanding of different features. In the drawings, like reference characters generally refer to like features (e.g., functionally similar and/or structurally similar elements).

FIG. 1 is a logic flow diagram illustrating facilitating management and/or automation of a bulk mail or direct mail campaign, according to one embodiment of the present invention.

FIG. 2 is a block diagram illustrating an example of a Bulk Mailing Management Application Server, a Bulk Mailing Management Database Server, a client device, and a supplier device, according to one embodiment of the present invention.

FIG. 3 is a logic flow diagram illustrating preparing a direct mail project, according to one embodiment of the present invention.

FIG. 4 is a data flow diagram illustrating processing project specifications and project bids, according to one embodiment of the present invention.

FIG. 5 is a logic flow diagram illustrating processing project specifications and project bids, according to one embodiment of the present invention.

FIG. 6 is a logic flow diagram illustrating processing project bids, according to one embodiment of the present invention.

FIG. 7 is a screenshot diagram illustrating creating a bulk mailing project specification, according to one embodiment of the present invention.

FIG. 8 is a screenshot diagram illustrating detecting errors in a bulk mailing project specification, according to one embodiment of the present invention.

FIG. 9 is a screenshot diagram illustrating verifying a bulk mailing project specification, according to one embodiment of the present invention.

FIG. 10 is a screenshot diagram illustrating specifying bidding criteria for a bulk mailing project specification, according to one embodiment of the present invention.

FIG. 11 is a screenshot diagram illustrating a completed bulk mailing project specification, according to one embodiment of the present invention.

FIG. 12 is a screenshot diagram illustrating a project management interface, according to one embodiment of the present invention.

FIG. 13 is a screenshot diagram illustrating a supplier user interface, according to one embodiment of the present invention.

FIG. 14 is a screenshot diagram illustrating specifying a bid for a bulk mailing project specification, according to one embodiment of the present invention.

FIG. 15 is a screenshot diagram illustrating viewing bids for a bulk mailing project specification, according to one embodiment of the present invention.

FIG. 16 is a screenshot diagram illustrating selecting bids for a bulk mailing project specification, according to one embodiment of the present invention.

FIG. 17 is a block diagram illustrating a second implementation of a bulk mailing management server, according to one embodiment of the present invention.

### DETAILED DESCRIPTION

Following below are more detailed descriptions of various concepts related to, and embodiments of, inventive methods, apparatuses and systems for facilitating management and/or automation of bulk mail or direct mail campaigns. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

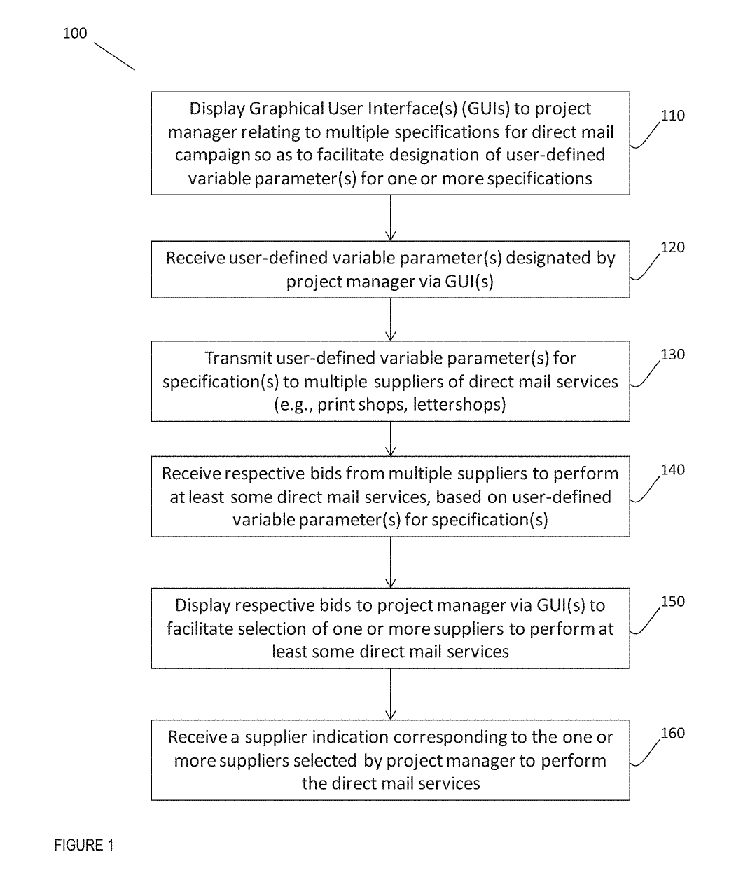

FIG. 1 is a logic flow diagram illustrating a process 100 for facilitating management and/or automation of a bulk mail or direct mail campaign, according to one embodiment of the present invention. For example, in some implementations, a graphical user interface (GUI) can be displayed 110, e.g., on a client device, such that a project manager can view multiple project specifications for a direct mail campaign, and such that the project manager can designate user-defined variable parameter(s) for one or more of the specifications. A Bulk Mailing Management Application Server can receive 120 the user-defined variable parameter(s) designated by the project manager, e.g., via the GUI. The Bulk Mailing Management Application Server can transmit 130 the user-defined variable parameter(s) for the one or more specifications to multiple suppliers of direct mail services (including print shops, letter shops, and/or any other suppliers described above). The Bulk Mailing Management Application Server can receive 140 bids from multiple suppliers to perform at least a portion of the direct mail services defined by the user-defined variable parameter(s) for the one or more specifications. The client device, after receiving bid information, can display 150 respective bids to the project manager, e.g., via at least one GUI, to facilitate selection of one or more suppliers to perform the portions of the direct mail services. The Bulk Mailing Management Application Server can then receive 160 a supplier indication corresponding to the one or more suppliers selected by the project manager to perform the portions of the direct mail services.

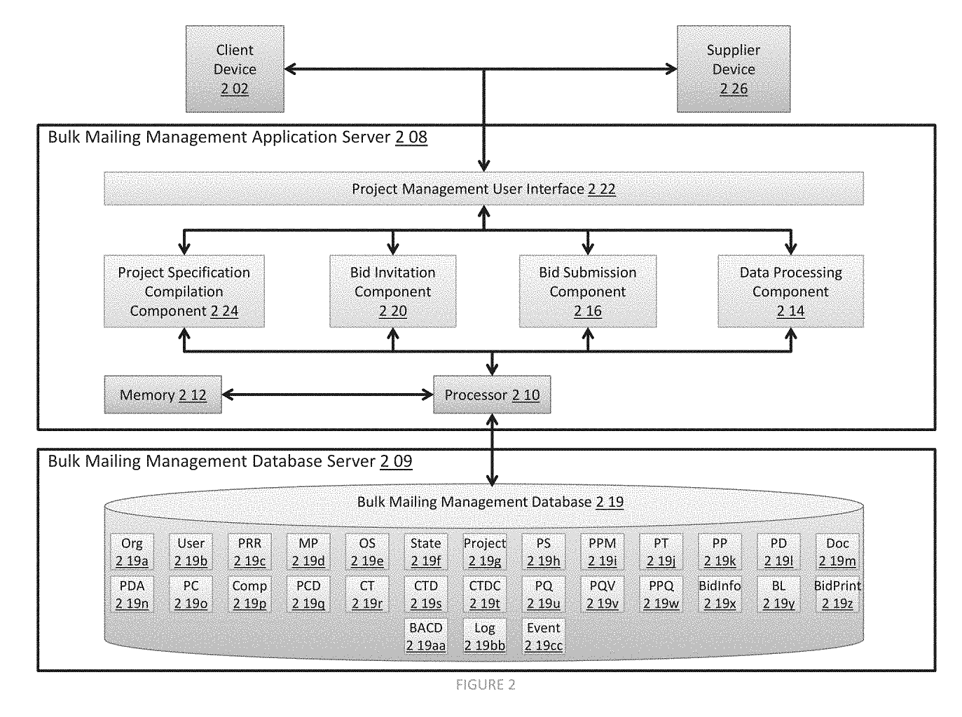

FIG. 2 is a block diagram illustrating an example of a Bulk Mailing Management Application Server 208, a Bulk Mailing Management Database Server 209, a Bulk Mailing Management Database 219, a client device 202, and a supplier device 226. In some implementations, each of the client device 202 and the supplier device 226 can be, for example, a mobile device (e.g., a mobile phone such as a smartphone, a tablet, and/or a like device, running iOS, Android, Windows Phone, and/or a similar mobile device Operating System (OS)), and/or a personal computer (e.g., a laptop and/or desktop machine running Windows, MacOS, Linux, and/or a similar desktop OS). The client device 202 can be configured to display a client interface (e.g., such as the project management user interface 222 hosted by the bulk mailing management application server 208), and to facilitate transfer of project manager input (e.g. project manager profile information, project specification data, and/or other such information) provided to the client interface, to the bulk mailing management application server 208. The supplier device 226, similarly, can be configured to facilitate transfer of supplier-related data (e.g., project bids, and/or profile information) to the bulk mailing management application server, e.g., via the project management user interface 222.

In one example, the bulk mailing management system may comprise two separate, independently scalable hardware devices, i.e., an application server and a database server. The bulk mailing management application server 208 and the bulk mailing management database server 209 can both include at least one processor and at least one memory each. The bulk mailing management database 219 is hosted on the bulk mailing management database server 209 and can be configured to store client data (e.g., supplier lists, project specifications, project templates, and/or other project manager data), and can interact with the bulk mailing management application server 208, and in turn the client device 202, to aid the project manager in defining portions of a project specification. The bulk mailing management database can also be configured to store supplier data (e.g., project bids, and/or other supplier-related data), and can interact with the bulk mailing management application server 208, and in turn the supplier device 226 to aid the supplier in bidding on and/or otherwise fulfilling bulk mail projects.

The bulk mailing management application server 208 can also include a number of modules implemented in hardware (e.g., in a circuit and/or other hardware device including at least one memory and/or at least one processor), software (e.g., in software code, a software object, and/or the like) implemented on hardware, such as a memory and/or a processor, or both hardware and software. Example modules include a data processing component 214, a bid submission component 216, a bid invitation component 220, and a project specification compilation component 224. The bulk mailing management application server 208 can use data in the bulk mailing management database 219 and the modules to obtain bulk mail project specification data, solicit project bids from suppliers, process project bids received from suppliers, and provide information about the project bids to a project manager, e.g., via the project management user interface 222. In some implementations, the bulk mail management application server 208 can be implemented on a platform such as ASP.NET, Ruby on Rails, or similar, with a backend Microsoft SQL Server 2012, PostgreSQL, MySQL, or similar for its database. A Simple Mail Transfer Protocol (SMTP) server can be used for sending email and SMS notifications. An ASP.NET or similar routing system, with standard .ASPX Web Form pages and .ASCX Web Controls, or similar dynamic markup technologies, with dedicated CSS style sheets can be used to route data to and/or from the bulk mail management application server, to generate user interfaces within the project management user interface, and/or for specifying the layout of pages hosted at the bulk mail management application server.

The bulk mailing management database 219 can include multiple tables including data (e.g., project manager data, supplier data, project specification data, bid data, and/or other data) used throughout the system. For example, an Organization table 219a includes fields such as, but not limited to: OrganizationID, OrganizationTypeID, OrganizationName, TaxID, TaxExempt, Address1, Address2, Address3, City, StateCode, Zip, DateCreated, SupplierListType, Phone, Extension, and/or Mobile. The organization table may support and/or track multiple client and/or supplier business accounts. A User table 219b includes fields such as, but not limited to: UserID, OrganizationID, RoleID, Email, Password, Salt, Title, FirstName, LastName, Phone, Extension, Mobile, MobileProviderName, UseAlternateAddress, Address1, Address2, Address3, City, StateCode, Zip, DateCreated, and/or DateActivated. The user table may support and/or track multiple user accounts.

A PasswordResetRequest table 219c includes fields such as, but not limited to: PasswordResetRequestID, UserID, ResetCode, and/or DateCodeSent. The PasswordResetRequest table may support and/or track multiple requests for resetting passwords. A MobileProvider table 219d includes fields such as, but not limited to: MobileProviderName and/or MobileProviderEmail Suffix. The MobileProvider table may support and/or track multiple mobile providers. An OrganizationSuppliers table 219e includes fields such as, but not limited to: OrganizationSupplierID, CustomerOrganizationID, SupplierOrganizationID, and/or the like. The OrganizationSuppliers table may support and/or track multiple suppliers. A State table 219f includes fields such as, but not limited to: StateCode and/or StateName. The State table may support and/or track multiple states and/or provinces.

A Project table 219g includes fields such as, but not limited to: ProjectID, ProjectName, OrganizationID, ProjectTypeID, CloneType, OriginProjectID, PrimaryPMUserID, ProjectDescription, DateCreated, HoldDate, ReadyForBidsDate, BidCutoffDateEntered, BidReviewAutoSetDate, BidsSelectedDate, BidsAwardedDate, MaiIDateEntered, MailIDroppedDate, and/or CompletedDate. The Project table may support and/or track multiple direct mail projects. A ProjectSuppliers table 219h includes fields such as, but not limited to: OrganizationID, ProjectID and/or Declined. The ProjectSuppliers table may support and/or track project suppliers. A ProjectPMs table 219i includes fields such as, but not limited to: ProjectID and/or PMUserID. The ProjectPMs table may support and/or track multiple project managers (PMs). A ProjectType table 219j includes fields such as, but not limited to: ProjectTypeID, ProjectTypeName, and/or Immutable. The ProjectType table may support and/or track multiple project types. A ProjectProperty table 219k includes fields such as, but not limited to: ProjectPropertyID, ProjectID, CategoryID, [Key], and/or Value. The State table may support and/or track multiple project properties and/or details. A ProjectDocument table 219l includes fields such as, but not limited to: ProjectDocumentID, DocumentID, ProjectID, AddedDate, AddedByUderID, ReviewRequired, ReviewDueDate, ReviewedByUserID, ReviewedDate, ReviewResponse, and/or ReviewComments. The ProjectDocument table may support and/or track multiple project documents.

A Document table 219m includes fields such as, but not limited to: DocumentID, Name, Description, Type, Document Size, DocumentSmallBlob, DocumentFileContentID, and/or DocumentFileContent. The Document table may support and/or track multiple project documents. A ProjectDocumentAccess table 219n includes fields such as, but not limited to: ProjectDocumentID, and/or SupplierOrganizationID. The ProjectDocumentAccess table may support and/or track permissions to access project documents.

A ProjectComponent table 2190 includes fields such as, but not limited to: ProjectComponentID, ProjectID, ComponentID, ComponentName, and/or Customize. The ProjectComponent table may support and/or track multiple project components. A Component table 219p includes fields such as, but not limited to: ComponentID, and/or ComponentName. The Component table may support and/or track multiple project components. A ProjectComponentData table 219q includes fields such as, but not limited to: ProjectComponentPropertyData, ProjectComponentID, ProkectComponentDataCategoryID, [Key], and/or Value. The ProjectComponentData table may support and/or track project component data. A ComponentTemplates table 219r includes fields such as, but not limited to: ComponentTemplateID, ComponentID, OrganizationID, TemplateName, and/or TemplateDescription. The ComponentTemplates table may support and/or track multiple component templates.

A ComponentTemplateData table 219s includes fields such as, but not limited to: ComponentTemplateDataPropertyID, ComponentTemplateID, ComponentDataCategoryID, [Key], and/or Value. The ComponentTemplateData table may support and/or track component template data. A ComponentTemplateDataCategory table 219t includes fields such as, but not limited to: ProjectComponentDataCategoryID, and/or ProjectComponentDataCategoryName. The ComponentTemplateDataCategory table may support and/or track project template category data.

A ProjectQuantity table 219u includes fields such as, but not limited to: ProjectQuantityID, ProjectID, Selected, OriginalQuantityValueID, AwardedQuantityValueID, and/or FinalQuantityValueID. The ProjectQuantity table may support and/or track multiple mailing quantities for projects. A ProjectQuantityValue table 219v includes fields such as, but not limited to: ProjectQuantityValueID, Quantity, DataProcessing, Postage, and/or Shipping. The ProjectQuantityValue table may support and/or track extra financial line items. A Proj ectPrintQuantity table 219w includes fields such as, but not limited to: ProjectPrintQuantityID, ProjectComponentID, ProjectQuantityID, OriginalPrintQuantity, AwardedPrintQuantity, and/or FinalPrintQuantity. The ProjectPrintQuantity table may support and/or track print quantities for various project components.

A BidInfo table 219x includes fields such as, but not limited to: BidInfoID, OrganizationID, ProjectID, DateSaved, DateSubmitted, and/or DateSelected. The BidInfo table may support and/or track bidding information for suppliers. A BidLettershop table 219y includes fields such as, but not limited to: BidLettershopID, ProjectQuantityID, BidInfoID, Selected, OriginalValue, AwardedValue, and/or FinalValue. The BidLettershop table may support and/or track bidding information for lettershops. A BidPrint table 219z includes fields such as, but not limited to: BidPrintID, BidInfoID, ProjectQuantityID, ProjectComponentID, Selected, OriginalValue, AwardedValue, and/or FinalValue. The BidPrint table may support and/or track print bid values for each invited supplier for each project component. A BidAdditionalCostsDiscounts table 219aa includes fields such as, but not limited to: BidAdditionalCostsDiscountsID, BidInfoID, ProjectQuantityID, OriginalValue, AwardedValue, and/or FinalValue. The BidAdditionalCostsDiscounts table may support and/or track additional costs for suppliers bidding on project components.

A Log table 219bb includes fields such as, but not limited to: LogID, ApplicationName, ApplicationVersion, MachineName, ClassName, Method, EventName, EventAction, ExceptionSource, ExceptionMessage, Form, URL, ExceptionStackTrace, ReferrerURL, IPAddress, InnerExceptionMessage, Emailed, and/or DateCreated. The Log table may support and/or track multiple records pertaining to unhandled exceptions. An Event table 219cc includes fields such as, but not limited to: EventID, ModifierUserID, Timestamp, ObjectID, ObjectType, EventType, Notification, Task, EmailList, SMSList, Context, and/or NewValue. The Event table may support and/or track multiple records pertaining to system notifications, messages, and/or tasks.

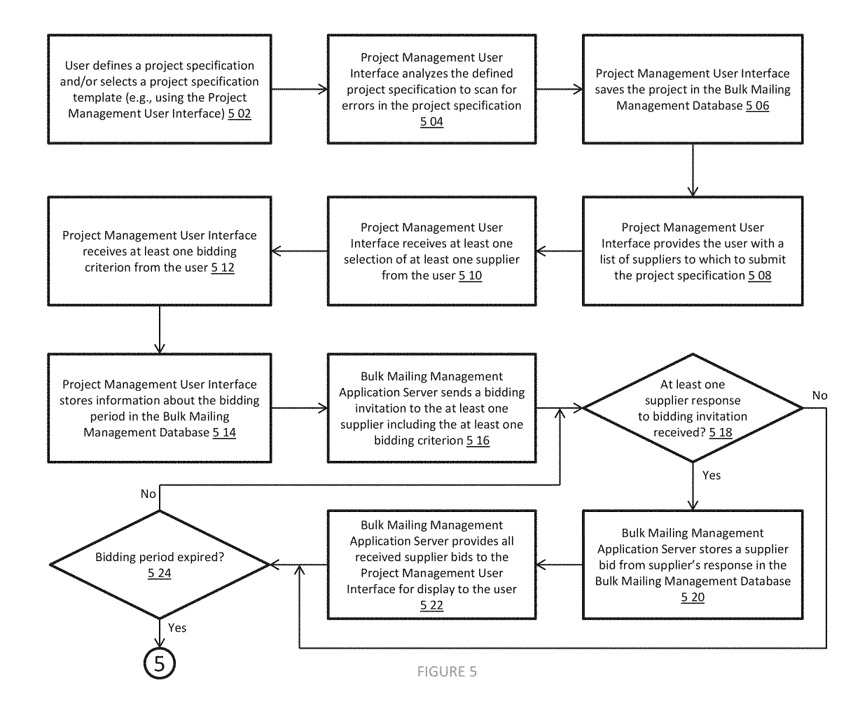

The data processing component 214 can receive data (e.g., project specification data, project specification template data, supplier list data) and/or a number of other types of data, e.g., via the at least one processor 210, and can format the data such that the data can be stored in the bulk mail management database 219, displayed in the project management user interface 222, and/or otherwise used by various modules of the bulk mailing management application server 208. The bid submission component 216 can facilitate bidding on project specifications, e.g., via providing bid functionality to the supplier, receiving supplier bids, e.g., via the at least one processor 210, and/or processing the supplier bid such that it can be stored in the bulk mail management database 219, and/or such that the supplier bid can be presented to the project manager. The bid submission component 216 can also enforce a bidding period time limit for supplier bids. The bid invitation component 220 can take project specification data provided by the project manager and, e.g., via the at least one processor 210, can format the project specification data such that it can be sent to a supplier, and such that the supplier can return a bid for the project. The project specification compilation component 224 can construct the project specification creation interface, e.g., displayed to the project manager via the project management user interface 222, and can receive the data the project manager provides for the project, and/or determine whether portions of the project specification being defined by the project manager are complete and/or do not contain other errors as described in FIG. 5.

The project management user interface 222 can be a user interface accessible by either the client device 202 and/or the supplier device 226, and can be hosted by and/or accessed from the bulk mailing management application server 208. The project management user interface 222 can receive inputs from the project manager and/or the supplier, and can provide the information to the bulk mailing management application server 208 and ultimately to the bulk mail management database 219 for processing. Additionally, the project management user interface 222 can display data from either the bulk mailing management application server 208 or the bulk mail management database 219 to the project manager and/or the supplier, e.g., via one or more Graphical User Interfaces (GUIs) designed to display project specification data, project bid data, and/or other related data. In some implementations, the project management user interface 222 can be implemented in HyperText Markup Language (HTML), CSS, JavaScript scripting language, and/or similar languages and/or platforms for specifying client-side web interfaces. In some implementations, the project management user interface 222 can be run within a web browser (including but not limited to Google Chrome, Internet Explorer, Firefox, and Safari) and/or similar software. The system settings for the bulk mail management application server 208 can be configured in a Web.config or similar file or set of files, including but not limited to customization for bulk mail management database connection settings and SMTP server settings.

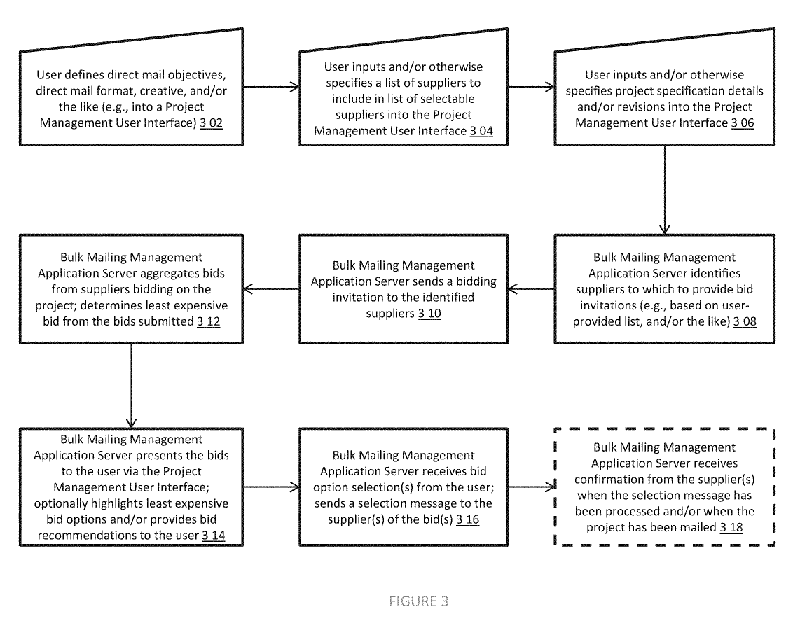

FIG. 3 is a logic flow diagram illustrating preparing a direct mail project. For example, in some implementations, a user (such as a project manager) can define 302 a direct mail project, e.g., by defining direct mail objectives, a direct mail format, creative data, and/or other direct mail parameters into a project management user interface 222. The project manager can input 304 and/or otherwise specify a list of suppliers to include in a list of selectable suppliers, into the project management user interface 222. For example, the project manager can manually enter suppliers into the project management user interface 222, and/or can, via the project management user interface 222, import a list stored within the bulk mailing management database 219. The project manager can also define a project specification for the direct mail project, e.g., by inputting and/or otherwise specifying 306 project specification details and/or project specification revisions into the project management user interface 222. Example project specification details can include the type of direct mail project, materials to use to print the direct mail project, where the direct mail campaign will be mailed, the content of the direct mail, direct mail formatting, and/or a variety of other such details related to the project specification.

The project management user interface 222 can send the project specification information to a bulk mailing management application server 208, which can in turn transmit the project specification information to the bulk mailing management database server 209 for storage within the bulk mailing management database 219. The bulk mailing management application server 208 can identify 308 suppliers to which to provide bid invitations, e.g., based on the project manager-provided list, and/or based on a project manager-curated subset of the project manager-provided list. The bulk mailing management application server 208 can then send 310 a bidding invitation to the identified suppliers. The suppliers can send bids via the project management user interface 222 to the bulk mailing management application server 208, which in turn can transmit the bid information to the bulk mailing management database server 209 for storage within the bulk mailing management database 219. The bulk mailing management application server 208 can aggregate 312 the bids received from the suppliers. In some implementations, suppliers can bid on an entire bulk mailing project, and/or on portions of the bulk mailing project (e.g., can bid exclusively on bulk mailing inserts for the bulk mailing project, and/or the inserts and envelope portions of a bulk mailing project, but not a main letter portion of a bulk mailing project). The bulk mailing management application server 208 can also optionally determine the least expensive bids obtained from the bids submitted. After a predetermined bidding period has expired, the bulk mailing management application server 208 can present 314 the aggregated bids to the project manager, e.g., via the project management user interface 222. The project management user interface 222 can optionally highlight the least expensive portions of the bids received from the suppliers, and/or can recommend to the user which bids to accept (e.g., based on the prices submitted). The bulk mailing management application server 208 can receive 316 the bid portion selections from the project manager, and can send a selection message to the one or more suppliers who submitted the bid portions. The selection message can include which portion of the bulk mailing project the one or more suppliers have been selected to fulfill, and/or the price agreed upon for fulfilling the portion of the bulk mailing project. The one or more suppliers can optionally confirm 318 with the bulk mailing management application server 208 that the one or more suppliers received a selection message, and/or can inform the bulk mailing management application server 208 when the one or more suppliers have processed and/or mailed out the bulk mailing project.

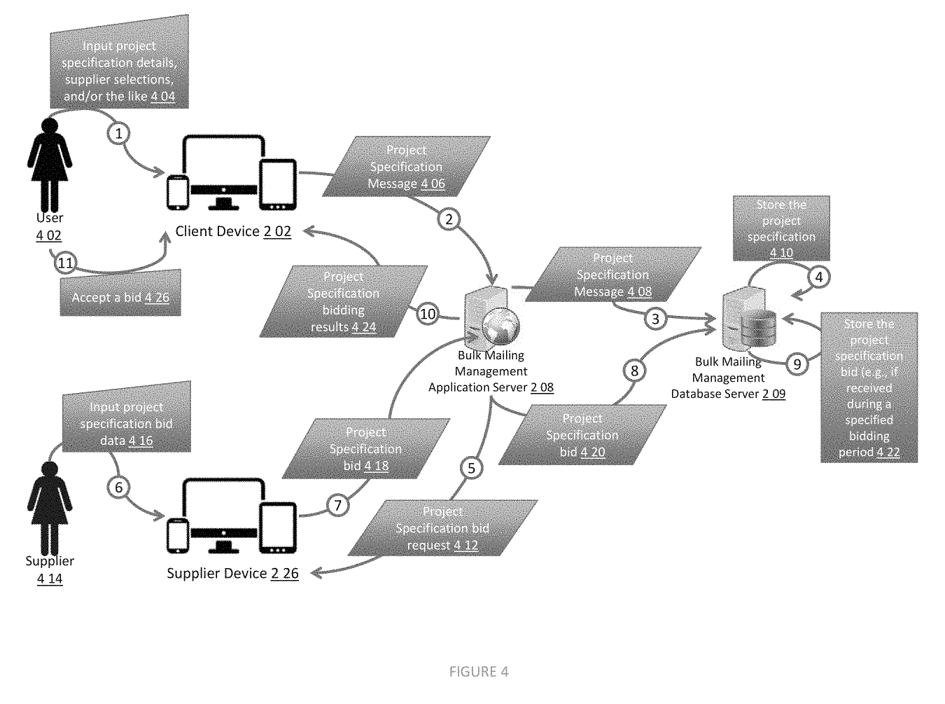

FIG. 4 is a data flow diagram illustrating processing project specifications and project bids. For example, in some implementations, a user (e.g., a project manager) 402 can input 404 project specification details, supplier selections and/or lists, and/or other such data relating to a bulk mailing project, into her client device 202. The client device 202 can provide the inputted project specification data 406 to the bulk mailing management application server 208, which can forward 408 the project specification data to the bulk mailing management database server 208 for storage within the bulk mailing management database 219. The bulk mailing management application server 208 can analyze portions of the project specification to determine how to format a project specification bid invitation, and can send 412 said bid invitation to at least one supplier 414, e.g., by sending the bid invitation via email retrievable via a supplier device 226. The bid invitation can include a bidding period and/or similar time limit for responding to the invitation, after which bids may not be accepted. The supplier can input 416 project specification bid data into the project management user interface 222 via her supplier device 226 (e.g., can input a bid for the entire project and/or a portion of the project). The supplier can send 418, via the supplier device 226, the project specification bid to the bulk mailing management application server 208, which can forward 420 the project specification bid to the bulk mailing management database server 209 for storage within the bulk mail mailing database 219. The bulk mailing management database server 209 can store 422 the project specification bid, e.g., so long as the bid was received during the specified bidding period. The bulk mailing management application server 208 can provide 424 project specification bids to the client device 202 via the project management user interface 222, e.g., in substantially real-time (e.g., as the project specification bids are received from suppliers), and/or at the end of the bidding period. The project manager can then choose to accept and/or reject 426 project specification bids (e.g., for the full project, and/or for portions of the project), and in some implementations may also reject a bid and request a revised bid (e.g., within the bidding period and prior to a deadline/time limit).

FIG. 5 is a logic flow diagram illustrating processing project specifications and project bids. For example, in some implementations, a user (e.g., a project manager) can define 502 a project specification, and/or can select a project specification template, e.g., via a project management user interface 222. The project management user interface can analyze 504 the defined project specification, e.g., to scan for errors in the project specification (e.g., missing information, conflicting project start and end dates, and/or other potential errors). The project management user interface 2022 can save 506 the project, e.g., by sending the project specification to the bulk mailing management database 219 via the bulk mailing management application server, and can provide 508 the user with a list of suppliers to which to submit the project specification to solicit project specification bids. The project management user interface 222 can receive, from the project manager, at least one selection 510 of at least one supplier from the list of suppliers, and at least one bidding criterion 512 from the user for the project specification. The bidding criterion can be a bidding period time limit, a minimum bid amount, and/or other information useful to include in a bidding invitation.

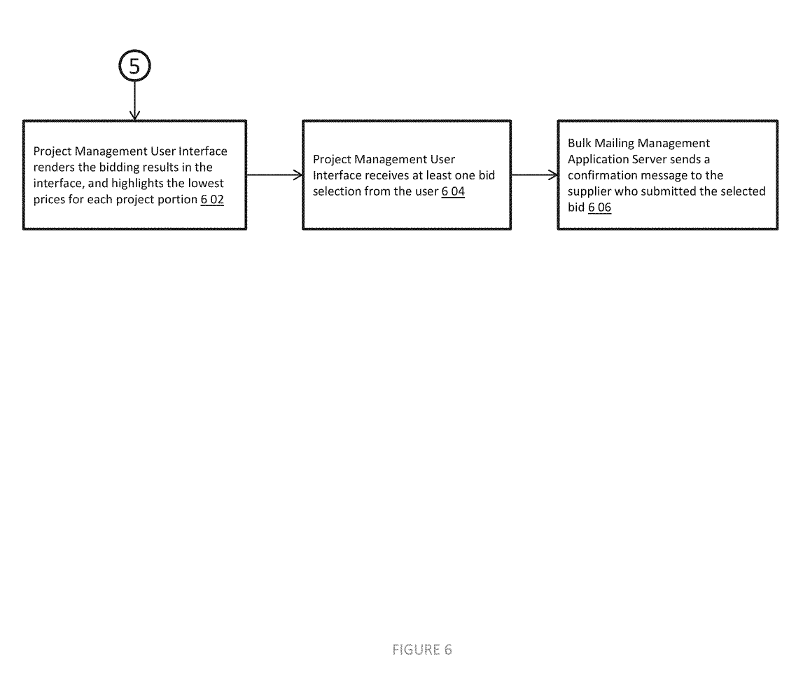

The project management user interface 222 can store 514 information about the bidding period and/or other bidding criteria, e.g., by sending the data to the bulk mailing management database 219. The bulk mailing management application server 208 can send 5016 a bidding invitation to the at least one supplier specified by the project manager, the bidding invitation including the at least one bidding criterion. If at least one supplier has responded to the bidding invitation 518, the bulk mailing management application server 208 can store 520 the supplier's bid in the bulk mailing management database 219, and can provide 522 the bid to the project manager, via providing the project management user interface 222 such that the project management user interface 222 can display the bid to the project manager in a GUI. If the bidding period has not expired 524 (e.g., if the current date and/or time is still before the deadline for submitting bids), the bulk mailing management application server 208 can continue to determine whether other suppliers have responded to a bidding invitation. If a supplier has not yet responded to the bidding invitation, the bulk mailing management server 208 can continue to determine if the bidding period has expired. If the bidding period has expired 524, then, referring to FIG. 6, the project management user interface 222 can render 602 the bidding results in the interface, and can optionally highlight and/or otherwise denote the lowest prices for each portion of the project, and/or the lowest price for the project as a whole. The project management user interface 222 can receive 604 at least one bid selection from the user, corresponding to bids for the project as a whole, and/or for portions of the project, and can forward the at least one selection to the bulk mailing management application server 208. The bulk mailing management application server 208 can then send 606 a confirmation message to the at least one supplier who submitted the selected bid, indicating that the bid made by the at least one supplier was accepted by the project manager. The supplier can optionally send notifications and/or data to the bulk mailing management application server 208, e.g., to confirm that it has received the bid acceptance message, to confirm that has completed and/or mailed out the project and/or its component of the project, and/or other such information.

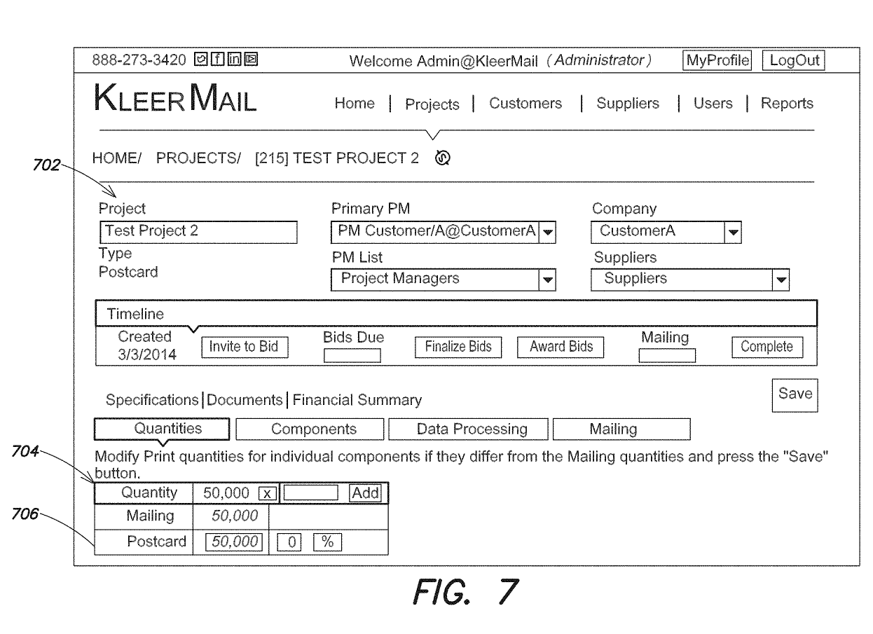

FIGS. 7-16 illustrate various example interfaces for facilitating the project specification definition and bidding processes described above in FIGS. 1-6. For example, in some implementations a project manager can provide and/or define a project specification 702 for at least one bulk mailing project, e.g., within the project management user interface 222. The project manager can define a quantity for the project as a whole 704, and/or for components 706 of the project. The project manager can also specify information about the project, such as a name, a company and/or project manager information for the project, as well as the type of printed material (e.g. a postcard, a self-mailer, a catalog and/or booklet, a generic letter package, or a personalized letter package) for the project. The project manager can also define other information about the components of the project (e.g., type of paper and/or other materials, size of materials, type of finish, type of ink used, and/or other such information), as well as provide a sample and/or media file to be used for the project. The project manager can also specify how the bulk mailing materials are printed and/or mailed. The project manager may provide this information while logged into a user profile account, as described above. From the project management user interface 222, the project manager can also import a project specification template for use in the bulk mailing project, and/or can save the defined project specification as a new project specification template.

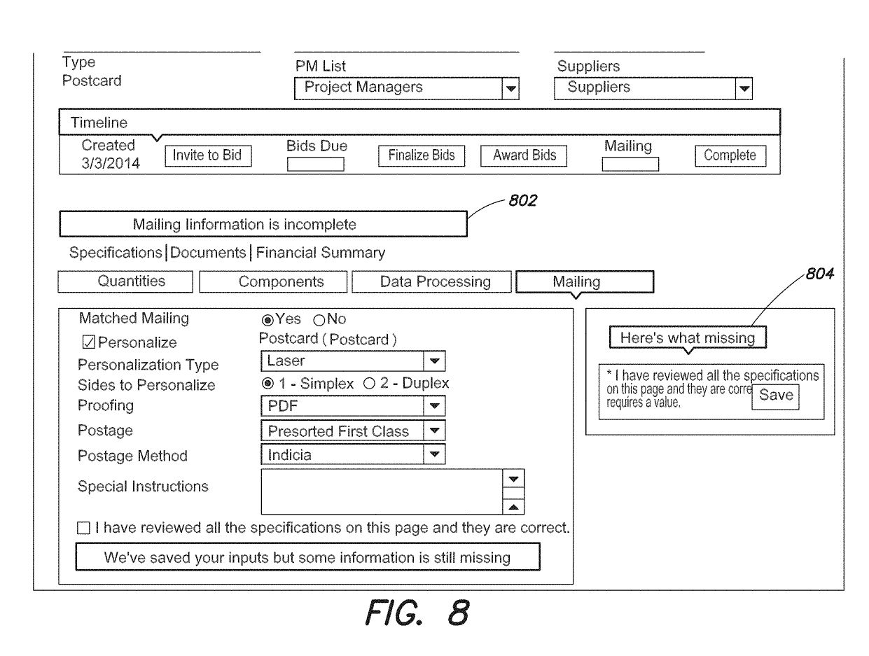

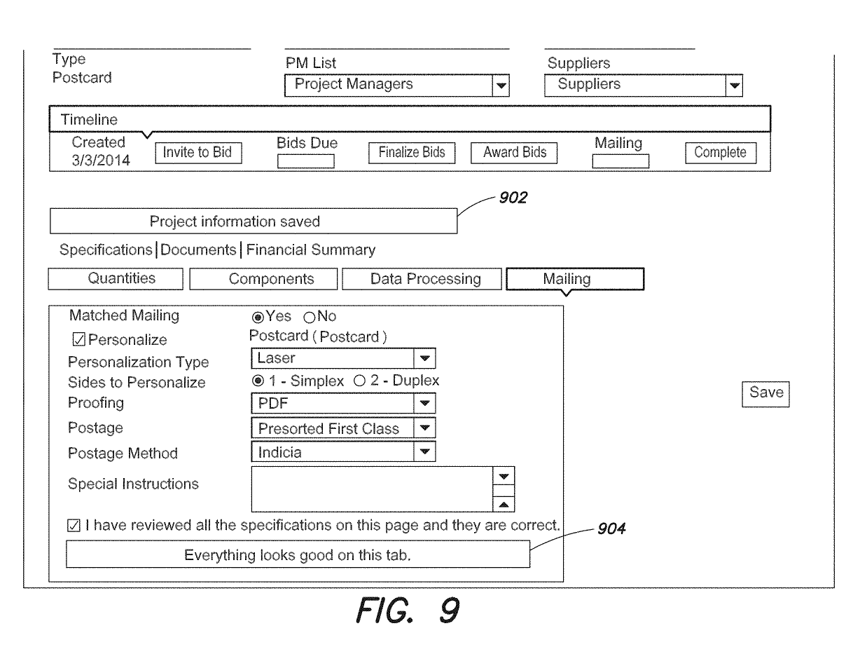

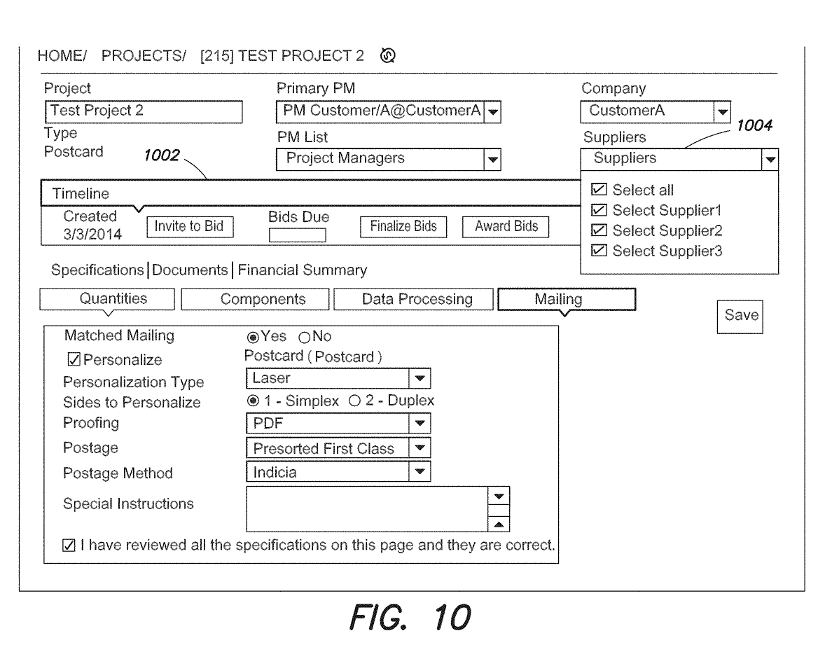

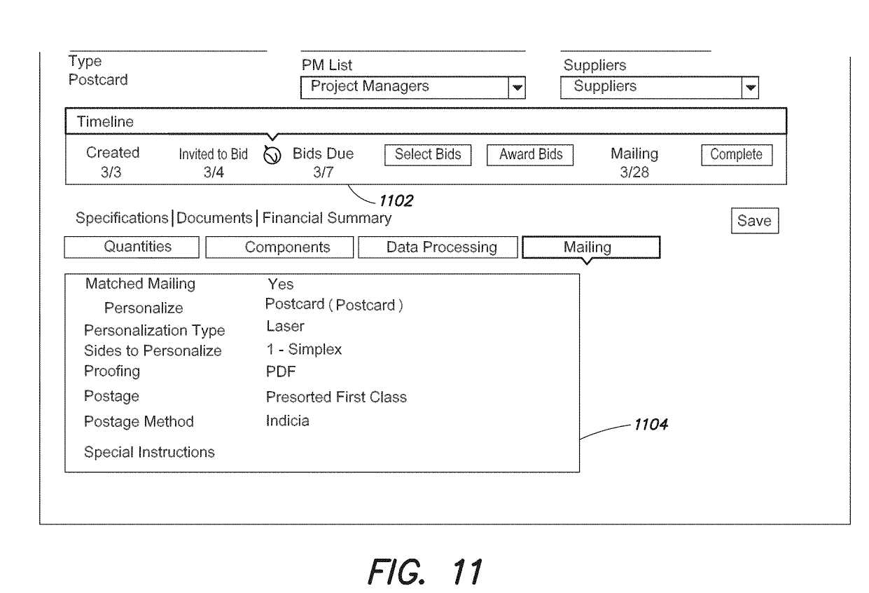

Referring to FIG. 8, when project managers do not complete the project specification and/or causes project specification errors (e.g., by omitting certain information, and/or by inputting incorrect and/or invalid information (e.g., inputting characters into a field requesting a numerical value)), the project management user interface 222 can display an error message 802 and can indicate 804 which portion(s) of the project specification are incomplete and/or contain other errors. Referring to FIG. 9, once a project manager has corrected errors detected in the project specification, the project management user interface 222 can display confirmation messages 902 showing that the project specification has been successfully saved, and indicating that no further errors were found 904 on the particular portion of the project specification that the project manager was working on. Referring to FIG. 10, the project manager may also specify a bidding period 1002 (e.g., a period of time during which suppliers can bid on the direct mail campaign project), as well as select suppliers 1004, e.g., from a project manager and/or bulk mailing management server-curated list of suppliers, to which to send bid invitations (e.g., invitations to submit estimated costs to the project manager for performing parts of, or all of, a direct mail campaign). Referring to FIG. 11, once the project manager has finalized the project specification, the bulk mailing management server 208 can send out bidding invitations, and indicate the date and/or time 1102 at which it has sent out the bidding invitations. The project manager may not be able to edit and/or change portions of the project specification once the bidding invitations have been sent 1104.

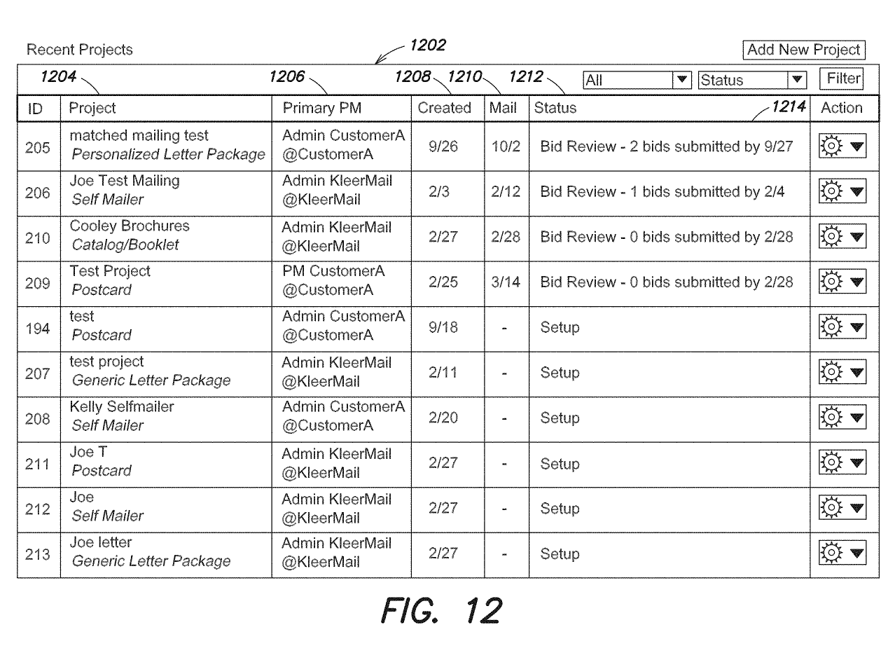

Referring to FIG. 12, the project manager may be able to access a “Recent Projects” portion 1202 of the project management user interface 222, where the project manager can view pending projects 1204, and/or bids 1214 submitted for the projects. The project manager can, for each pending project, also view a summary of the project information, including the project name 1204, the primary project manager 1206 and/or company for the pending project, when the project was created 1208, when the project manager wants the project to be mailed 1210, and the current status 1212 of the project (e.g., incomplete, sent out for bidding, bid reviewing phase, and/or completed).

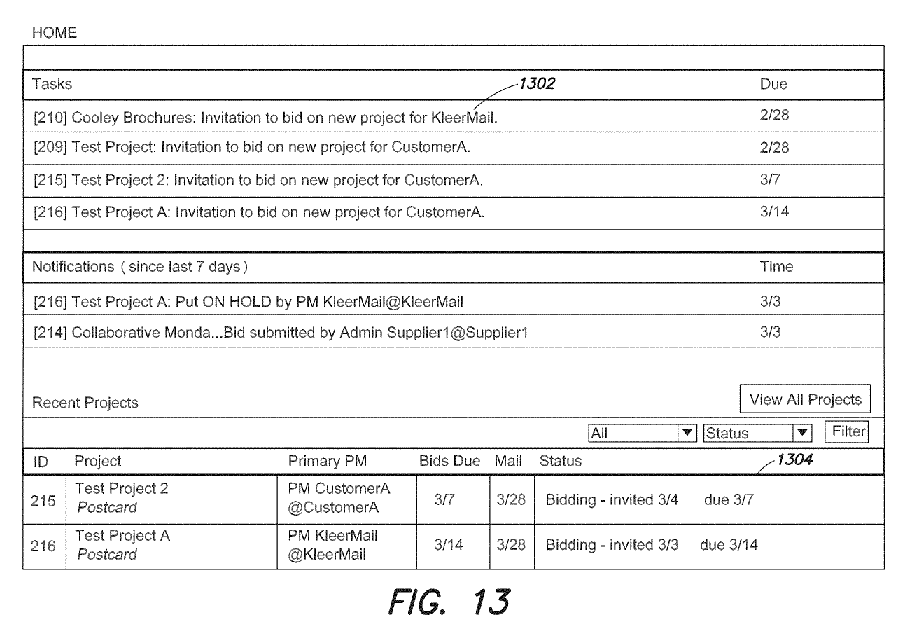

The bulk mailing management server 208 may process the project manager's data and provide it to the suppliers which the project manager provided and/or selected, e.g., via the processes described above. Referring to FIG. 13, the supplier, in some implementations, can view the bid invitation 1302 sent by the project manager, e.g., in a notification window displaying pending bid invitations. The supplier can also see the invitation within a “Recent Projects” portion of the interface, which can also indicate a status 1304 for the bid invitation (e.g., the deadline for providing a bid, whether the supplier has submitted a bid, started to submit a bid, and/or has not yet submitted a bid for the project). The supplier can also view data on the name of the project, when the project manager wishes the project to be mailed, and/or project manager information, such as the name of the project manager and/or the project manager's company.

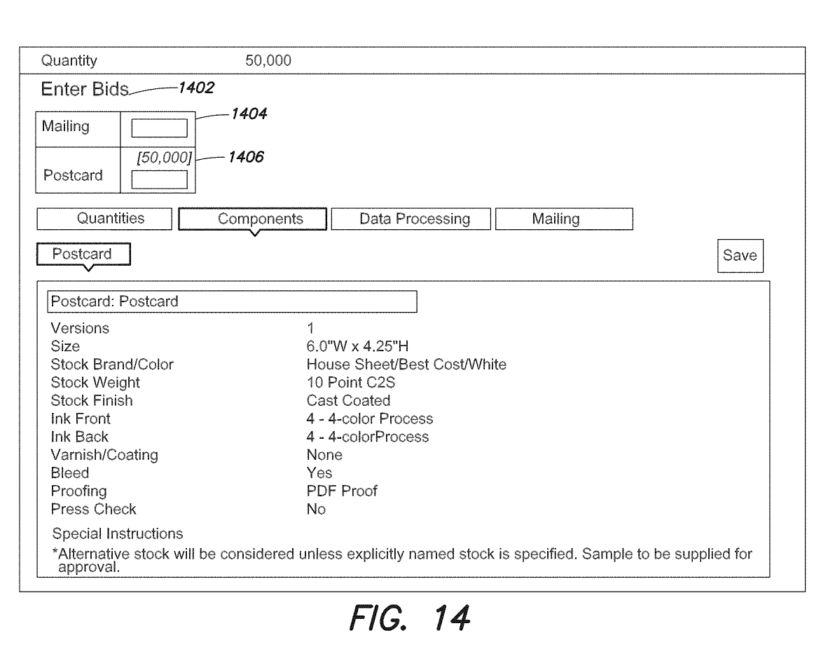

Once having access to various project specifications, referring to FIG. 14, respective suppliers may place bids 1402 to provide services for one or more aspects of the campaign. For example, if the campaign includes mailing costs 1404 and printed material costs 1406, e.g., such as printing costs for postcard elements, the supplier can provide a bid for the cost to mail the project as a whole, and/or the cost to produce the postcards to be mailed in the bulk mailing campaign. The supplier can view all of the data specified by the project manager in the project specification, such as the specifications for the postcard and/or other mailing materials, how the postcard should be printed and/or mailed, and/or other such information.

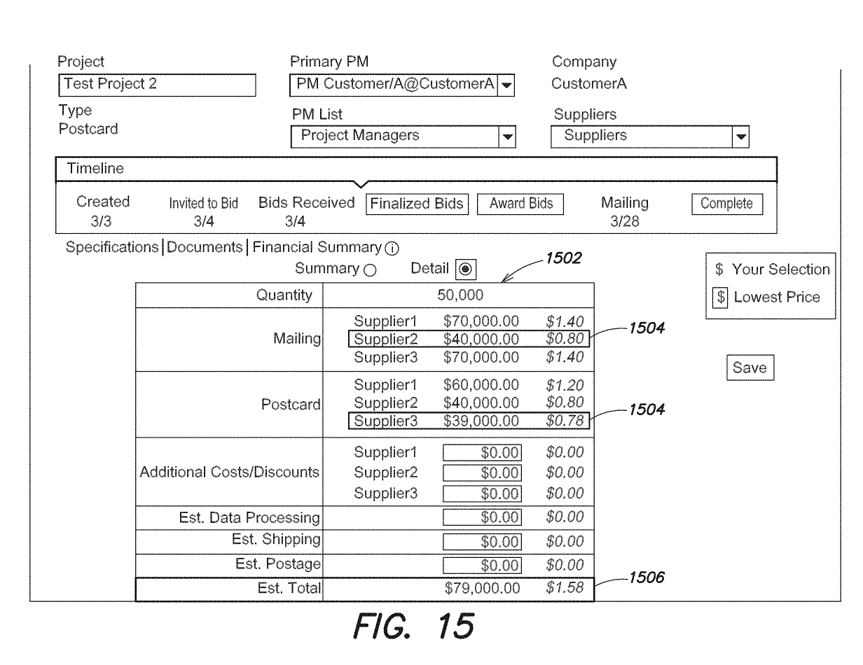

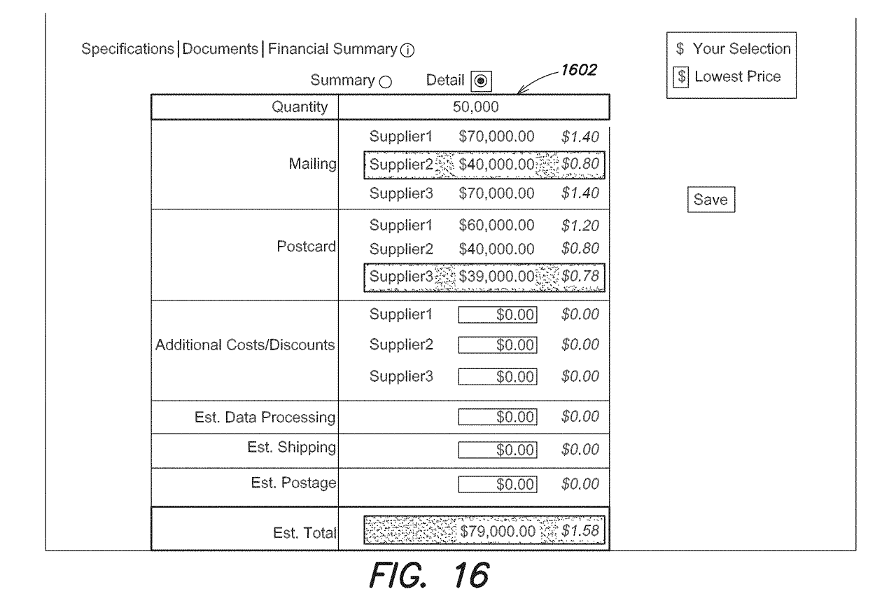

Referring to FIG. 15, the project manager can select a link leading to a summary 1502 of the bids submitted by suppliers (e.g., after a project manager-specified bidding period has ended). In some implementations, the lowest bid 1504 for each component of printed material may be highlighted and/or otherwise noted to the project manager such that the project manager may quickly view the lowest cited prices for each component. The interface can also provide the total cost of the lowest-cost components combined 1506. For example, Supplier 1 can bid $70,000 for the cost of mailing, and $60,000 for the cost of producing the specified postcards; Supplier 2 can bid $40,000 for the cost of mailing, and $40,000 for the cost of producing the specified postcards; and finally, Supplier 3 can bid $70,000 for the cost of mailing the project, and $39,000 for the cost of producing the specified postcards. In this example, Supplier 2 submits the lowest bid for mailing the bulk mailing campaign, and Supplier 3 submits the lowest bid for producing the postcards. Thus, the interface can highlight Supplier 2's mailing bid, and Supplier 3's postcard bid. If any of the suppliers submit additional cost and/or discounts for their bids, this data may also be augmented by the interface (e.g., the highest discount can be highlighted, and/or the lowest additional costs can be highlighted). The total cost can, therefore, be based on the costs of components being fulfilled by more than one supplier. Referring to FIG. 16, the project manager can then select 1602 bids for the components of the project, and/or an overall bid for the project. For example, using the example above, the project manager can select Supplier 2's mailing bid, and Supplier 3's postcard bid. In another example, the project manager can exclusively select Supplier 2's bids, and/or another supplier's bids, instead of selecting bids from different suppliers. The estimated total cost of the project can be updated based on the project manager's selections. The project manager may then be able to confirm which bids are accepted and/or rejected and submit the order to the appropriate supplier(s) for processing.

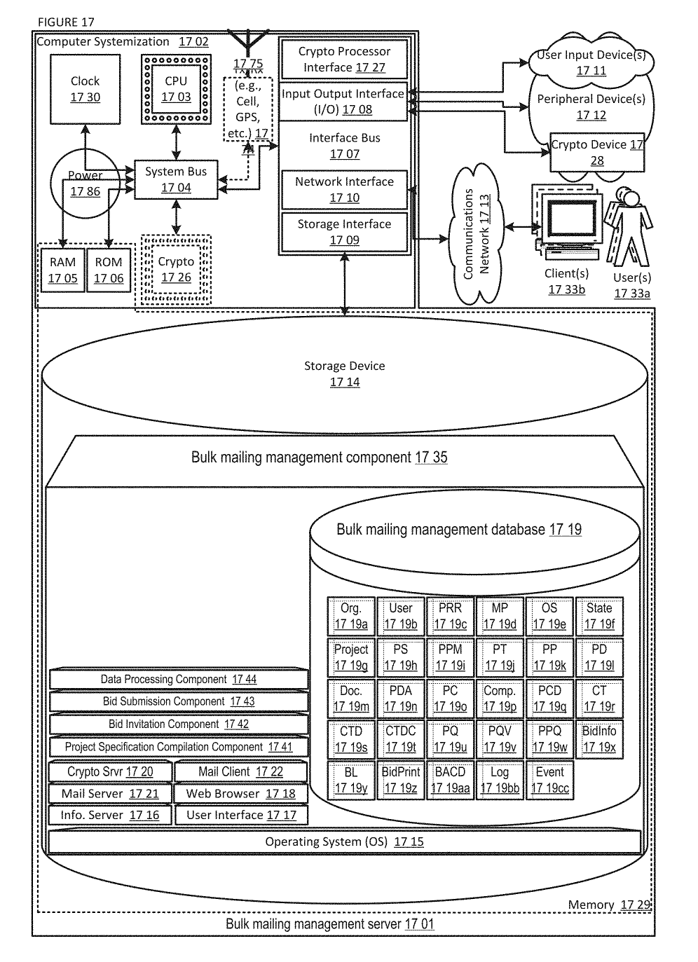

FIG. 17 shows a block diagram illustrating a second implementation of a bulk mailing management server. In various embodiments, the bulk mailing management server 1701 may serve various data storage, communication and/or processing functions (e.g., aggregate, process, store, search, serve, identify, instruct, generate, match) and generally facilitate interactions with one or more client computing devices (e.g., employed by users and/or suppliers).

Typically, users, which may be people and/or other systems, may engage information technology systems (e.g., computers) to facilitate information processing. In turn, computers employ processors to process information; such processors 1703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the bulk mailing management server 1701 may be connected to and/or communicate with entities such as, but not limited to: one or more users from user input devices 1711; peripheral devices 1712; an optional cryptographic processor device 1728; and/or a communications network 1713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The bulk mailing management server 1701 may be based on computer systems that may comprise, but are not limited to, components such as: a computer systemization 1702 connected to memory 1729.

### Bulk Mailing Management Server Systemization

A computer systemization 1702 may comprise a clock 1730, central processing unit (“CPU(s)” and/or “processor(s)” (these terms are used interchangeable throughout the disclosure unless noted to the contrary)) 1703, a memory 1729 (e.g., a read only memory (ROM) 1706, a random access memory (RAM) 1705, etc.), and/or an interface bus 1707, and most frequently, although not necessarily, are all interconnected and/or communicating through a system bus 1704 on one or more (mother)board(s) 1702 having conductive and/or otherwise transportive circuit pathways through which instructions (e.g., binary encoded signals) may travel to effectuate communications, operations, storage, etc. The computer systemization may be connected to a power source 1786; e.g., optionally the power source may be internal. Optionally, a cryptographic processor 1726 and/or transceivers (e.g., ICs) 1774 may be connected to the system bus. In another embodiment, the cryptographic processor and/or transceivers may be connected as either internal and/or external peripheral devices 1712 via the interface bus I/O. In turn, the transceivers may be connected to antenna(s) 1775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing bulk mailing management server 1701 to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the bulk mailing management server 1701 and beyond through various interfaces. Should processing requirements dictate a greater amount speed and/or capacity, distributed processors (e.g., Distributed bulk mailing management server), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the bulk mailing management server 1701 may be achieved by implementing a microcontroller such as CAST's R8051XC2 microcontroller; Intel's MCS 51 (i.e., 8051 microcontroller); and/or the like. Also, to implement certain features of the bulk mailing management server 1701, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the bulk mailing management server 1701 component collection (distributed or otherwise) and/or features may be implemented via the microprocessor and/or via embedded components; e.g., via ASIC, coprocessor, DSP, FPGA, and/or the like. Alternately, some implementations of the bulk mailing management server 1701 may be implemented with embedded components that are configured and used to achieve a variety of features or signal processing.

Depending on the particular implementation, the embedded components may include software solutions, hardware solutions, and/or some combination of both hardware/software solutions. For example, bulk mailing management server features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the bulk mailing management server features. A hierarchy of programmable interconnects allow logic blocks to be interconnected as needed by the bulk mailing management server system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the bulk mailing management server 1701 may be developed on regular FPGAs and then migrated into a fixed version that more resembles ASIC implementations. Alternate or coordinating implementations may migrate bulk mailing management server features to a final ASIC instead of or in addition to FPGAs. Depending on the implementation all of the aforementioned embedded components and microprocessors may be considered the “CPU” and/or “processor” for the bulk mailing management server 1701.

### Power Source

The power source 1786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1786 is connected to at least one of the interconnected subsequent components of the bulk mailing management server 1701 thereby providing an electric current to all subsequent components. In one example, the power source 1786 is connected to the system bus component 1704. In an alternative embodiment, an outside power source 1786 is provided through a connection across the I/O 1708 interface. For example, a USB and/or IEEE 1394 connection carries both data and power across the connection and is therefore a suitable source of power.

### Interface Adapters

Interface bus(ses) 1707 may accept, connect, and/or communicate to a number of interface adapters, conventionally although not necessarily in the form of adapter cards, such as but not limited to: input output interfaces (I/O) 1708, storage interfaces 1709, network interfaces 1710, and/or the like. Optionally, cryptographic processor interfaces 1727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1709 may accept, communicate, and/or connect to a number of storage devices such as, but not limited to: storage devices 1714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1710 may accept, communicate, and/or connect to a communications network 1713. Through a communications network 1713, the bulk mailing management server 1701 is accessible through remote clients 1733b (e.g., computers with web browsers) by users 1733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed bulk mailing management servers), architectures may similarly be employed to pool, load balance, and/or otherwise increase the communicative bandwidth required by the bulk mailing management server 1701. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1710 may be used to engage with various communications network types 1713. For example, multiple network interfaces may be employed to allow for the communication over broadcast, multicast, and/or unicast networks.

Input Output interfaces (I/O) 1708 may accept, communicate, and/or connect to user input devices 1711, peripheral devices 1712, cryptographic processor devices 1728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1711 often are a type of peripheral device and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1712 may be connected and/or communicate to I/O and/or other facilities of the like such as network interfaces, storage interfaces, directly to the interface bus, system bus, the CPU, and/or the like. Peripheral devices may be external, internal and/or part of the bulk mailing management server 1701. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the bulk mailing management server 1701 may be embodied as an embedded, dedicated, and/or monitor-less (i.e., headless) device, wherein access would be provided over a network interface connection.

Cryptographic units such as, but not limited to, microcontrollers, processors 1726, interfaces 1727, and/or devices 1728 may be attached, and/or communicate with the bulk mailing management server 1701. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1729. However, memory is a fungible technology and resource, thus, any number of memory embodiments may be employed in lieu of or in concert with one another. It is to be understood that the bulk mailing management server 1701 and/or a computer systemization may employ various forms of memory 1729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1729 will include ROM 1706, RAM 1705, and a storage device 1714. A storage device 1714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1729 may contain a collection of program and/or database components and/or data such as, but not limited to: operating system component(s) 1715 (operating system); information server component(s) 1716 (information server); user interface component(s) 1717 (user interface); Web browser component(s) 1718 (Web browser); database(s) 1719; mail server component(s) 1721; mail client component(s) 1722; cryptographic server component(s) 1720 (cryptographic server); the bulk mailing management server component(s) 1735, including components 1741-1744; and/or the like (i.e., collectively a component collection). These components may be stored and accessed from the storage devices and/or from storage devices accessible through an interface bus. Although non-conventional program components such as those in the component collection, typically, are stored in a local storage device 1714, they may also be loaded and/or stored in memory such as: peripheral devices, RAM, remote storage facilities through a communications network, ROM, various forms of memory, and/or the like.

### Operating System

The operating system component 1715 is an executable program component facilitating the operation of the bulk mailing management server 1701. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the bulk mailing management server 1701 to communicate with other entities through a communications network 1713. Various communication protocols may be used by the bulk mailing management server 1701 as a subcarrier transport mechanism for interaction, such as, but not limited to: multicast, TCP/IP, UDP, unicast, and/or the like.

### Information Server

An information server component 1716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the bulk mailing management server 1701 based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the bulk mailing management database 1719, operating systems, other program components, user interfaces, Web browsers, and/or the like.

Access to the bulk mailing management database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the bulk mailing management server 1701. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the bulk mailing management server 1701 as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the bulk mailing management server-enabled nodes. The combined application may be nugatory on systems employing standard Web browsers.

### Mail Server

A mail server component 1721 is a stored program component that is executed by a CPU 1703. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the bulk mailing management server 1701.

Access to the bulk mailing management server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1722 is a stored program component that is executed by a CPU 1703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1720 is a stored program component that is executed by a CPU 1703, cryptographic processor 1726, cryptographic processor interface 1727, cryptographic processor device 1728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the bulk mailing management server 1701 may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the bulk mailing management server component to engage in secure transactions if so desired. The cryptographic component facilitates the secure accessing of resources on the bulk mailing management server 1701 and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Bulk Mailing Management Database

The bulk mailing management database component 1719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the bulk mailing management database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the bulk mailing management database is implemented as a data-structure, the use of the bulk mailing management database 1719 may be integrated into another component such as the bulk mailing management server component 1735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1719 includes several tables 1719a-cc. An Organization table 1719a includes fields such as, but not limited to: OrganizationID, OrganizationTypeID, OrganizationName, TaxID, TaxExempt, Address1, Address2, Address3, City, StateCode, Zip, DateCreated, DateRegistered, DateAdded, SupplierListType, Email, FirstName, LastName, Title, Phone, Extension, and/or Mobile. The organization table may support and/or track multiple client and/or supplier business accounts on a bulk mailing management server 1701. A User table 1719b includes fields such as, but not limited to: UserID, OrganizationID, RoleID, Email, Password, Salt, Title, FirstName, LastName, Phone, Extension, Mobile, MobileProviderName, UseAlternateAddress, Address1, Address2, Address3, City, StateCode, Zip, DateCreated, and/or DateActivated. The user table may support and/or track multiple user accounts on a bulk mailing management server 1701. A PasswordResetRequest table 1719c includes fields such as, but not limited to: PasswordResetRequestID, UserID, ResetCode, and/or DateCodeSent. The PasswordResetRequest table may support and/or track multiple requests for resetting passwords on a bulk mailing management server 1701. A MobileProvider table 1719d includes fields such as, but not limited to: MobileProviderName and/or MobileProviderEmail Suffix. The MobileProvider table may support and/or track multiple mobile providers on a bulk mailing management server 1701. An OrganizationSuppliers table 1719e includes fields such as, but not limited to: OrganizationSupplierID, CustomerOrganizationID, SupplierOrganizationID, and/or the like. The OrganizationSuppliers table may support and/or track multiple supplier accounts on a bulk mailing management server 1701. A State table 1719f includes fields such as, but not limited to: StateCode and/or StateName. The State table may support and/or track multiple states and/or provinces on a bulk mailing management server 1701.

A Project table 1719g includes fields such as, but not limited to: ProjectID, ProjectName, OrganizationID, ProjectTypeID, CloneType, OriginProjectID, PrimaryPMUserID, ProjectDescription, DateCreated, HoldDate, ReadyForBidsDate, BidCutoffDateEntered, BidReviewAutoSetDate, BidsSelectedDate, BidsAwardedDate, MaiIDateEntered, MailIDroppedDate, and/or CompletedDate. The Project table may support and/or track multiple direct mail projects on a bulk mailing management server 1701. A ProjectSuppliers table 1719h includes fields such as, but not limited to: OrganizationID, ProjectID and/or Declined. The ProjectSuppliers table may support and/or track project suppliers on a bulk mailing management server 1701. A ProjectPMs table 1719i includes fields such as, but not limited to: ProjectID and/or PMUserID. The ProjectPMs table may support and/or track multiple project project managers (PMs) on a bulk mailing management server 1701. A ProjectType table 1719j includes fields such as, but not limited to: ProjectTypeID, ProjectTypeName, and/or Immutable. The ProjectType table may support and/or track multiple projecy types on a bulk mailing management server 1701. A ProjectProperty table 1719k includes fields such as, but not limited to: ProjectPropertyID, ProjectID, CategoryID, [Key], and/or Value. The State table may support and/or track multiple project properties and/or details on a bulk mailing management server 1701. A ProjectDocument table 17191 includes fields such as, but not limited to: ProjectDocumentID, DocumentID, ProjectID, AddedDate, AddedByUderID, ReviewRequired, ReviewDueDate, ReviewedByUserID, ReviewedDate, ReviewResponse, and/or ReviewComments. The ProjectDocument table may support and/or track multiple project documents on a bulk mailing management server 1701.

A Document table 1719m includes fields such as, but not limited to: DocumentID, Name, Description, Type, Document Size, DocumentSmallBlob, DocumentFileContentID, and/or DocumentFileContent. The Document table may support and/or track multiple project documents on a bulk mailing management server 1701. A ProjectDocumentAccess table 1719n includes fields such as, but not limited to: ProjectDocumentID, and/or SupplierOrganizationID. The ProjectDocumentAccess table may support and/or track permissions to access project documents on a bulk mailing management server 1701. A ProjectComponent table 17190 includes fields such as, but not limited to: ProjectComponentID, ProjectID, ComponentID, ComponentName, and/or Customize. The ProjectComponent table may support and/or track multiple project components on a bulk mailing management server 1701. A Component table 1719p includes fields such as, but not limited to: ComponentID, and/or ComponentName. The Component table may support and/or track multiple project components on a bulk mailing management server 1701. A ProjectComponentData table 1719q includes fields such as, but not limited to: ProjectComponentPropertyData, ProjectComponentID, ProkectComponentDataCategoryID, [Key], and/or Value. The ProjectComponentData table may support and/or track project component data on a bulk mailing management server 1701. A ComponentTemplates table 1719r includes fields such as, but not limited to: ComponentTemplateID, ComponentID, OrganizationID, TemplateName, and/or TemplateDescription. The ComponentTemplates table may support and/or track multiple component templates on a bulk mailing management server 1701. A ComponentTemplateData table 1719s includes fields such as, but not limited to: ComponentTemplateDataPropertyID, ComponentTemplateID, ComponentDataCategoryID, [Key], and/or Value. The ComponentTemplateData table may support and/or track component template data on a bulk mailing management server 1701. A ComponentTemplateDataCategory table 1719t includes fields such as, but not limited to: ProjectComponentDataCategoryID, and/or ProjectComponentDataCategoryName. The ComponentTemplateDataCategory table may support and/or track project template category data on a bulk mailing management server 1701.

A ProjectQuantity table 1719u includes fields such as, but not limited to: ProjectQuantityID, ProjectID, Selected, OriginalQuantityValueID, AwardedQuantityValueID, and/or FinalQuantityValueID. The ProjectQuantity table may support and/or track multiple mailing quantities for projects on a bulk mailing management server 1701. A ProjectQuantityValue table 1719v includes fields such as, but not limited to: ProjectQuantityValueID, Quantity, DataProcessing, Postage, and/or Shipping. The ProjectQuantityValue table may support and/or track extra financial line items on a bulk mailing management server 1701. A ProjectPrintQuantity table 1719w includes fields such as, but not limited to: ProjectPrintQuantityID, ProjectComponentID, ProjectQuantityID, OriginalPrintQuantity, AwardedPrintQuantity, and/or FinalPrintQuantity. The ProjectPrintQuantity table may support and/or track print quantities for various project components on a bulk mailing management server 1701.

A BidInfo table 1719x includes fields such as, but not limited to: BidInfoID, OrganizationID, ProjectID, DateSaved, DateSubmitted, and/or DateSelected. The BidInfo table may support and/or track bidding information for suppliers on a bulk mailing management server 1701. A BidLettershop table 1719y includes fields such as, but not limited to: BidLettershopID, ProjectQuantityID, BidInfoID, Selected, OriginalValue, AwardedValue, and/or FinalValue. The BidLettershop table may support and/or track bidding information for lettershops on a bulk mailing management server 1701. A BidPrint table 1719z includes fields such as, but not limited to: BidPrintID, BidInfoID, ProjectQuantityID, ProjectComponentID, Selected, OriginalValue, AwardedValue, and/or FinalValue. The BidPrint table may support and/or track print bid values for each invited supplier for each project component on a bulk mailing management server 1701. A BidAdditionalCostsDiscounts table 1719aa includes fields such as, but not limited to: BidAdditionalCostsDiscountsID, BidInfoID, ProjectQuantityID, OriginalValue, AwardedValue, and/or FinalValue. The BidAdditionalCostsDiscounts table may support and/or track additional costs for suppliers bidding on project components on a bulk mailing management server 1701.

A Log table 1719bb includes fields such as, but not limited to: LogID, ApplicationName, ApplicationVersion, MachineName, ClassName, Method, EventName, EventAction, ExceptionSource, ExceptionMessage, Form, URL, ExceptionStackTrace, ReferrerURL, IPAddress, InnerExceptionMessage, Emailed, and/or DateCreated. The Log table may support and/or track multiple records pertaining to unhandled exceptions on a bulk mailing management server 1701. An Event table 1719cc includes fields such as, but not limited to: EventID, ModifierUserID, Timestamp, ObjectID, ObjectType, EventType, Notification, Task, EmailList, SMSList, Context, and/or NewValue. The Event table may support and/or track multiple records pertaining to system notifications, messages, and/or tasks on a bulk mailing management server 1701.

In one embodiment, the bulk mailing management database may interact with other database systems. For example, employing a distributed database system, queries and data access by search bulk mailing management server component may treat the combination of the bulk mailing management database, an integrated data security layer database as a single database entity.

In one embodiment, user programs may contain various user interface primitives, which may serve to update the bulk mailing management server 1701. Also, various accounts may require custom database tables depending upon the environments and the types of clients the bulk mailing management server 1701 may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1719a-cc. The bulk mailing management server 1701 may be configured to keep track of various settings, inputs, and parameters via database controllers.

The bulk mailing management database may communicate to and/or with other components in a component collection, including itself, and/or facilities of the like. Most frequently, the bulk mailing management database communicates with the bulk mailing management server component, other program components, and/or the like. The database may contain, retain, and provide information regarding other nodes and data.

### The Bulk Mailing Management Server Component

The bulk mailing management server component 1735 is a stored program component that is executed by a CPU. In one embodiment, the bulk mailing management server component incorporates any and/or all combinations of the aspects of the bulk mailing management server 1701 that was discussed in the previous figures. As such, the bulk mailing management server 1701 affects accessing, obtaining and the provision of information, services, transactions, and/or the like across various communications networks. The features and embodiments of the bulk mailing management server 1701 discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the bulk mailing management server 1701's features and facilities, and in many cases reduce the costs, energy consumption/requirements, and extend the life of bulk mailing management server 1701's underlying infrastructure; this has the added benefit of making the bulk mailing management server 1701 more reliable. Similarly, many of the features and mechanisms are designed to be easier for users to use and access, thereby broadening the audience that may enjoy/employ and exploit the feature sets of the bulk mailing management server 1701; such ease of use also helps to increase the reliability of the bulk mailing management server 1701. In addition, the feature sets include heightened security as noted via the Cryptographic components 1720, 1726, 1728 and throughout, making access to the features and data more reliable and secure.

The bulk mailing management server 1701 transforms Organization 1719a, Project 1719g, and BidInfo 1719x inputs via bulk mailing management server 1701's Project Specification Compilation 1741, Bid Invitation 1742, Bid Submission 1743, and Data Processing 1744 components into ProjectPrintQuantity 1719w and/or direct mail campaign outputs.

The bulk mailing management server component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the bulk mailing management server employs a cryptographic server to encrypt and decrypt communications. The bulk mailing management server component may communicate to and/or with other components in a component collection, including itself, and/or facilities of the like. Most frequently, the bulk mailing management server component communicates with the bulk mailing management database, operating systems, other program components, and/or the like. The bulk mailing management server 1701 may contain, communicate, generate, obtain, and/or provide program component, system, user, and/or data communications, requests, and/or responses.

### Distributed Bulk Mailing Management Servers

The structure and/or operation of any of the bulk mailing management server node components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the bulk mailing management server 1701 will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
   where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the bulk mailing management server 1701 may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:
http://www.xay.com/perl/site/lib/SOAP/Parser.html
http://publib.boulder.ibm.com/infocenter/tivihelp/v2r1/index.jsp?topic=/com.ibm.IBMDI.doc/referenceguide295.htm
and other parser implementations:
http://publib.boulder.ibm.com/infocenter/tivihelp/v2r1/index.jsp?topic=/com.ibm.IBMDI.doc/referenceguide259.htm
all of which are hereby expressly incorporated by reference.

### CONCLUSION

While various embodiments have been described and illustrated herein, a variety of other means and/or structures for performing the function and/or obtaining the results and/or one or more of the advantages described herein, and each of such variations and/or modifications is deemed to be within the scope of the disclosure. More generally, all parameters, dimensions, materials, and configurations described herein are meant to be examples and that the actual parameters, dimensions, materials, and/or configurations will depend upon the specific application or applications. It is, therefore, to be understood that the foregoing embodiments are presented by way of example only.

The above-described embodiments can be implemented in any of numerous ways. For example, embodiments of designing and making the mobile configuration files and mobile application layouts disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the mobile configuration files and mobile application layouts disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the disclosure discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods described herein need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various aspects of the description discussed herein may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for facilitating management, by at least one project manager, of a direct mail campaign to generate and deliver printed promotional material to a target audience including multiple direct mail recipients, the apparatus comprising:
at least one communication interface;
a memory to store processor-executable instructions; and
at least one processor communicatively coupled to the at least one communication interface and the memory, wherein upon execution by the at least one processor of at least some of the processor-executable instructions stored in the memory, the at least one processor controls the at least one communication interface to:
A) electronically transmit first information for electronically displaying to the at least one project manager, on at least one project manager computer communicatively coupled to the at least one communication interface, at least one graphical user interface (GUI) relating to a plurality of specifications for the direct mail campaign, each specification of the plurality of specifications having at least one user-defined variable parameter, the at least one (GUI) facilitating at least one designation by the at least one project manager of the at least one user-defined variable parameter for at least one specification of the plurality of specifications;
B) electronically receive the at least one user-defined variable parameter for the at least one specification, from the at least one project manager computer, based at least in part on the at least one designation by the at least one project manager via the at least one GUI;
C) electronically transmit the at least one user-defined variable parameter for the at least one specification for the direct mail campaign to multiple suppliers of direct mail lettershop services, via a respective plurality of supplier computers communicatively coupled to the at least one communication interface, wherein the multiple suppliers are identified in a supplier list or supplier database that is stored in the at least one memory and/or electronically received via the at least one communication interface;
D) electronically receive respective bids from the multiple suppliers, via the respective plurality of supplier computers, to perform at least some of the direct mail lettershop services, based at least in part on the at least one user-defined variable parameter for the at least one specification electronically transmitted in C);
E) electronically transmit second instructions for displaying to the at least one project manager, via the at least one GUI of the at least one project manager computer, the respective bids electronically received in D) from the multiple suppliers, the at least one (GUI) facilitating selection by the at least one project manager of at least one of the multiple suppliers to perform the at least some of the direct mail lettershop services; and
F) electronically receive, from the at least one project manager computer, a supplier indication corresponding to the at least one of the multiple suppliers to perform the at least some of the direct mail lettershop services, based at least in part on the selection by the at least one project manager via the at least one GUI displayed on the at least one project manager computer.

2-37. (canceled)
